(19) United States
(12) Patent Application Publication
(10) Pub. No.: US 2026/0172417 A1
(43) Pub. Date: Jun. 18, 2026

(54) DYNAMIC AUTHENTICATION VIA AN AUTHENTICATION INTERMEDIATOR

(71) Applicant: Cisco Technology, Inc., San Jose, CA (US)

(72) Inventor: Frédérick Laflèche, Verdun (CA)

(21) Appl. No.: 19/037,488

(22) Filed: Jan. 27, 2025

Related U.S. Application Data
(60) Provisional application No. 63/735,092, filed on Dec. 17, 2024.

(51) Int. Cl. H04L 9/40

(52) U.S. Cl. CPC H04L 63/083

(57) ABSTRACT

Techniques are provided for instantiating an authentication session with a user based on one or more authentication methods. In one embodiment, a method includes receiving, by an authentication intermediator, a login identifier for a user and requesting, by the authentication intermediator, one or more authentication methods associated with the login identifier from a centralized authentication server, wherein the one or more authentication methods are configured to authenticate the user to a system or a device via the centralized authentication server, and wherein the centralized authentication server is separate from the system or the device. The method further includes obtaining, by the authentication intermediator, the one or more authentication methods from the centralized authentication server based on the login identifier and instantiating, by the authentication intermediator, an authentication session with the user based on the one or more authentication methods.

### CROSS-REFERENCE TO RELATED APPLICATION

The application claims the benefit of priority under 35 U.S.C. § 119(e) to U.S. Provisional Application No. 63/735,092, filed on Dec. 17, 2024, which is hereby incorporated by reference in its entirety.

### TECHNICAL FIELD

The present disclosure relates to instantiating an authentication session with a user based on one or more authentication methods dynamically obtained via an authentication intermediator.

### BACKGROUND

Many institutions (e.g., government agencies, government contractors, healthcare providers, etc.) need to comply with security requirements and/or guidelines (e.g., Federal Risk and Authorization Management Program (FedRAMP), Department of Defense's Security Technical Implementation Guides (STIGs), etc.) to protect the integrity of their assets (e.g., computing or network devices and/or systems). For example, certain security requirements may include the use of a centralized Authentication, Authorization and Accounting (AAA) server and implementation of multiple authentication methods. Compliance with these security requirements is an ever-moving target because devices and/or systems are to be configured to accommodate newly developed authentication methods. Further, it is challenging to configure resource-constrained (e.g., low memory and/or low CPU) devices and/or systems deployed in large numbers over various sites to comply with security requirements. Thus, updating devices and/or systems to support the required authentication methods is often costly and time-consuming.

### BRIEF DESCRIPTION OF THE DRAWINGS

FIG. 1 is a block diagram illustrating a system for instantiating an authentication session with a user via an authentication intermediator, according to an example embodiment.

FIG. 2 is a block diagram illustrating a system for instantiating an authentication session with a user via an authentication intermediator, according to an example embodiment.

FIG. 3 is a block diagram illustrating a system for configuring a device and/or system via an orchestrator and authenticating a user to the device and/or system, according to an example embodiment.

FIG. 4 is a flowchart illustrating a method for selecting one or more authentication methods, according to an example embodiment.

FIG. 5A and FIG. 5B are an operational sequence diagram illustrating a method for authenticating a user via an authentication intermediator, according to an example embodiment.

FIG. 6A and FIG. 6B are an operational sequence diagram illustrating a method for authenticating a user via an authentication intermediator using multi-factor authentication, according to an example embodiment.

FIG. 7A and FIG. 7B are an operational sequence diagram illustrating a method for authenticating a user via an authentication intermediator using multi-factor authentication, according to an example embodiment.

FIG. 8A is a flow diagram illustrating a method for authenticating a user based on one or more authentication methods associated with the user, according to an example embodiment.

FIG. 8B is diagram illustrating a user interface displaying one or more prompts to a user, according to an example embodiment.

FIG. 9A and FIG. 9B are an operational sequence diagram illustrating a method for authenticating a user via an authentication intermediator using a single sign-on method, according to an example embodiment.

FIG. 10A is a flow diagram illustrating a method for authenticating a user based on one or more authentication methods associated with the user, according to an example embodiment.

FIG. 10B is diagram illustrating a user interface displaying instructions to a user to complete authentication via an authentication URL, according to an example embodiment.

FIG. 11A and FIG. 11B are an operational sequence diagram illustrating a method for authenticating a user via an authentication intermediator using multi-factor authentication, according to an example embodiment.

FIG. 12 is a diagram illustrating a user interface displaying one or more prompts to a user, according to an example embodiment.

FIG. 13 is a operational sequence diagram illustrating a method for configuring a device and/or system via an orchestrator, according to an example embodiment.

FIG. 14A is a diagram illustrating data fields and corresponding description associated with an authentication intermediator, according to an example embodiment.

FIG. 14B is a diagram illustrating error types and corresponding description associated with instantiation of an authentication session, according to an example embodiment.

FIG. 14C is a diagram illustrating data fields and corresponding description associated with obtaining authentication credentials from a user, according to an example embodiment.

FIG. 14D is a diagram illustrating data fields and corresponding description associated with a polling operation, according to an example embodiment.

FIG. 15 is a block diagram illustrating a system for providing authentication services via an authentication intermediator, according to an example embodiment.

FIG. 16 is a flow diagram illustrating a method for instantiating an authentication session with a user, according to an example embodiment.

FIG. 17 is a hardware block diagram of a computing device that may perform functions associated with operations discussed herein in connection with the techniques depicted.

### DETAILED DESCRIPTION

### Overview

Techniques are provided for instantiating an authentication session with a user based on one or more authentication methods. In one embodiment, a method includes receiving, by an authentication intermediator, a login identifier for a user, wherein the login identifier includes a username, and requesting, by the authentication intermediator, one or more authentication methods associated with the login identifier from a centralized authentication server, wherein the one or more authentication methods are configured to authenticate the user to a system or a device via the centralized authentication server, and wherein the centralized authentication server is separate from the system or the device. The method further includes obtaining, by the authentication intermediator, the one or more authentication methods from the centralized authentication server based on the login identifier and instantiating, by the authentication intermediator, an authentication session with the user based on the one or more authentication methods.

The techniques provided herein leverage an authentication intermediator and centralized authentication server to implement one or more authentication methods. Thus, an authentication client can be agnostic to the actual implementation of an authentication method. This minimizes configuration on a device and/or system the user desires to access since the device and/or system do not need to be configured each time a new authentication method is added. Additional authentication methods may also be supported without the need to update the device and/or system. The techniques provided herein may be implemented to authenticate a user to any device and/or system that requires authentication.

Conventional techniques, such as delegated authentication, require delegation to a third party to manage user authentication (e.g., delegation to Lightweight Directory Access Protocol (LDAP), Remote Authentication Dial-In User Service (RADIUS), Terminal Access Controller Access-Control System (TACACS), etc.). In delegated authentication, the device still needs specific implementation and/or configuration to communicate with an authentication server directly. Further, delegated authentication requires connection to one or more third-party services, which may require additional resources and/or time. In contrast, the techniques provided herein leverage an authentication intermediator that can implement multiple authentication methods without the need to update or configure the device and/or system for each authentication method, thereby providing a dynamic authentication process while ensuring compliance with security requirements.

### Example Embodiments

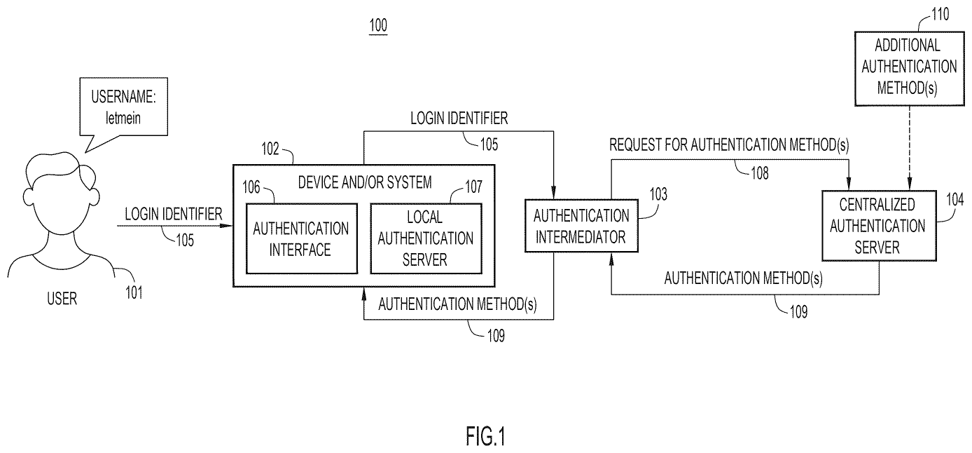

Reference is first made to FIG. 1, for a description of a block diagram illustrating a system 100 for instantiating an authentication session with a user via an authentication intermediator, according to an example embodiment. The system 100 includes a user 101, a device and/or system 102, an authentication intermediator 103, and a centralized authentication server 104. The user 101 may request access to the device and/or system 102 by providing one or more authentication credentials, such as a login identifier 105, to the device and/or system 102. The login identifier 105 may include username, phone number, email address, biometric data (e.g., fingerprint, retina, or face recognition), security passcodes or tokens (e.g., one-time passcodes), or any suitable identifier that can verify a user's identity. In certain embodiments, the login identifier may be unique to one user or to a group of users.

The device and/or system 102 includes an authentication interface 106 and a local authentication server 107. The authentication interface 106 may include a command line interface (CLI), a computer or mobile application, a website, a graphical user interface, or any interface capable of receiving one or more authentication credentials from the user 101. In certain embodiments, the local authentication server 107 may be a local Authentication, Authorization and Accounting/Auditing (AAA) server configured to authorize the user 101 to access the device and/or system 102 based on one or more user permissions and track user access information (e.g., login timestamp, session duration, etc.).

In certain embodiments, the device and/or system 102 may include a user device and/or a network device. The user device may include a mobile phone, a tablet, a laptop, etc. The network device may include a router, a modem, a switch, a gateway, etc. through which network traffic may travel. For example, the network device may enable communication between a user device and a network. The network may include a local area network (LAN), a wide area network (WAN) such as the Internet, or a combination thereof, and includes wired, wireless, or fiber optic connections, with numerous network devices through which network traffic may travel. In certain embodiments, the device and/or system 102 may include a computer system, a software system, a virtual system (e.g., virtual machine), a physical system, a website, or any other suitable system. The software system may include a software application, such as a desktop application, a mobile application, a web application accessible through a web browser, etc.

For example, the user 101 may request access to the device and/or system 102 by providing, via the authentication interface 106, the login identifier 105 to the device and/or system 102. Upon receiving the login identifier 105, the device and/or system 102 may provide the login identifier 105 (e.g., username “letmein”) to the authentication intermediator 103. In certain embodiments, the authentication intermediator 103 may be located in the cloud or locally on a network. In one example, the authentication intermediator 103 may be a function running on a server or a computing device that is separate from the device and/or system 102. Moreover, the authentication intermediator 103 may be configured to perform intermediation between the local authentication server 107 and the centralized authentication server 104.

In certain embodiments, the centralized authentication server 104 may be a centralized Authentication, Authorization and Accounting/Auditing (AAA) server configured to store one or more authentication methods associated with one or more users. For example, the centralized authentication server 104 may include a database configured to store one or more authentication methods 109 associated with the user 101 identified by the login identifier 105. In certain embodiments, the centralized authentication server 104 may store one or more passwords/passcodes corresponding to the login identifier 105 for each password-based authentication method. In one example, the user 101 may provide as input the username “letmein.” The centralized authentication server 104 may indicate that two authentication methods are associated with the username “letmein” (e.g., a one-time password method and a validation link method).

Upon receiving the login identifier 105 from the device and/or system 102, the authentication intermediator 103 is configured to send a request 108 for one or more authentication methods associated with the login identifier 105 to the centralized authentication server 104. That is, for example, the authentication intermediator 103 may validate the login identifier 105 with the centralized authentication server 104. The centralized authentication server 104 may provide an indication whether a match to the login identifier 105 is found in its database. Once validated, the authentication intermediator 103 may request and retrieve one or more authentication methods 109 associated with the login identifier 105 from the centralized authentication server 104. Then, the authentication intermediator 103 is configured to provide the one or more authentication methods 109 to the device and/or system 102 for user selection. In certain embodiments, the one or more authentication methods 109 may be displayed to the user 101 via a graphical user interface of the device and/or system 102.

Further, the database in the centralized authentication server 104 may be updated as the login identifier 105 is associated with one or more additional authentication methods 110. For example, when the device and/or system 102 is required to authenticate the user 101 via a new authentication method in compliance with security requirements, the database in the centralized authentication server 104 may be updated accordingly to reflect that the one or more additional authentication methods 110 are associated with the login identifier 105. In certain embodiments, the centralized authentication server 104 is separate from the device and/or system 102. For example, the centralized authentication server 104 may be located in the cloud. Thus, the techniques provided herein can be leveraged to dynamically implement one or more additional authentication methods (e.g., newly developed authentication methods) without reconfiguring the device and/or system, thereby providing an efficient and robust authentication framework.

In certain embodiments, only one authentication method may be associated with the login identifier 105. In these embodiments, the user 101 may be prompted to authenticate via the authentication method. In certain embodiments, a plurality of authentication methods may be associated with the login identifier 105. In these embodiments, the plurality of authentication methods may include one or more primary authentication methods and/or one or more secondary authentication methods. The plurality of authentication methods may be displayed to the user for selection, where the one or more primary authentication methods are presented to the user for selection prior to the one or more secondary authentication methods being presented.

In certain embodiments, the authentication intermediator 103 may be configured to instantiate an authentication session with the user 101 based on one or more authentication methods selected by the user 101. For example, when the user 101 selects a one-time password (OTP) method, the authentication intermediator 103 is configured to authenticate the user 101 via the OTP method in the authentication session. In certain embodiments where the selected authentication method is a password-based authentication method, the authentication intermediator 103 may authenticate the user 101 by matching credentials provided by the user 101 (e.g., login identifier and password) with those stored in the database of the centralized authentication server 104. In embodiments where user selection is not allowed, the authentication intermediator 103 is configured to authenticate the user via one or more authentication methods 109 provided by the centralized authentication server 104.

Upon successfully authenticating the user 101, the authentication intermediator 103 is configured to determine one or more permissions and/or roles associated with the user 101. For example, authentication credentials of user A (e.g., having the role of “Viewer”) may be associated with permission to access a website, while authentication credentials of user B (e.g., having the role of “Administrator”) may be associated with permissions to access and edit the website. Then, the authentication intermediator 103 is configured to transmit the one or more permissions and/or roles and a session identifier to the local authentication server 107. In certain embodiments, the one or more permissions and/or roles and session identifier may be transmitted to the local authentication server 107 via an authentication intermediator library in the device and/or system 102. In a session instantiated based on the session identifier, the local authentication server 107 is configured to authorize the user 101 access to the device and/or system 102 (and/or their resources, services, etc.) in accordance with the one or more permissions and/or roles. That is, for example, the user 101 may take actions in the device and/or system 102 in accordance with the one or more permissions (e.g., read access, write access, delete access, etc.) and/or roles (e.g., “Viewer,” “Administrator,” etc.).

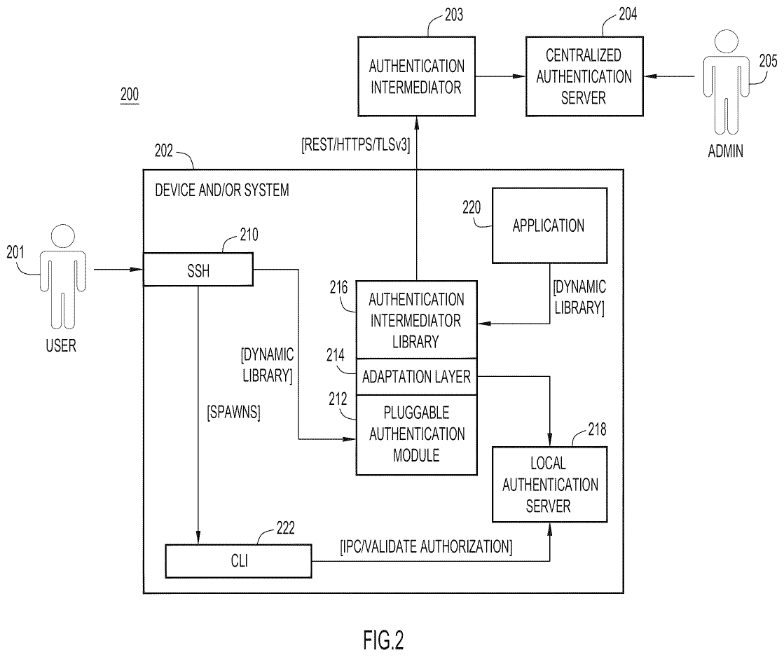

Reference is now made to FIG. 2, for a description of a block diagram illustrating a system for instantiating an authentication session with a user via an authentication intermediator, according to an example embodiment. The system 200 includes a user 201, a device and/or system 202, an authentication intermediator 203, a centralized authentication server 204, and an administrator 205 (“admin”). The device and/or system 202 includes an authentication interface (e.g., a Secure Shell 210 (SSH)), a pluggable authentication module 212 (PAM), an adaptation layer 214, an authentication intermediator library 216, a local authentication server 218, an application 220, and a command line interface 222. The user 201 may connect to a SSH server via the Secure Shell 210, and the SSH server may initiate a connection with the pluggable authentication module 212 through a dynamic library. In certain embodiments, instead of the Secure Shell 210, the authentication interface may be a console (e.g., serial port), a local web service, or any suitable authentication interface. In certain embodiments, the user may provide the login identifier to one or more applications and/or interfaces that may use the authentication intermediator 203 directly or indirectly via the pluggable authentication module 212.

The pluggable authentication module 212 may be configured to initialize the authentication intermediator library 216. The authentication intermediator library 216 may be configured to interface a server-side authentication intermediator (e.g., authentication intermediator 203) with a local authentication server (e.g., local authentication server 218). The authentication intermediator library 216 may be a library with an adaptation layer (e.g., adaptation layer 214) configured for local specifics. For example, the adaptation layer 214 may be configured to implement specific adaptation between the authentication intermediator library 216 and a local system or subsystem (e.g., local authentication server 218) of the device and/or system 202. In one embodiment, the application 220 may initiate a connection with the authentication intermediator library 216 via a dynamic library.

In certain embodiments, the authentication intermediator 203 may be located in the cloud or locally on a network. In one example, the authentication intermediator 203 is a function running on a server or computing device that is separate from the device and/or system 202. For example, the authentication intermediator 203 is configured to perform intermediation between the centralized authentication server 204 and the local authentication server 218. In certain embodiments, the centralized authentication server 204 may be a centralized Authentication, Authorization and Accounting/Auditing (AAA) server configured to store one or more authentication methods associated with one or more users. In certain embodiments, the local authentication server 218 may be a local Authentication, Authorization and Accounting/Auditing (AAA) server configured to authorize user access to the device and/or system 202 based on user permissions and track user access information (e.g., login timestamp, session duration, etc.). Moreover, in certain embodiments, the authentication intermediator library 216 may interface with the authentication intermediator 203 via a Representational State Transfer (REST) framework, a Hypertext Transfer Protocol Secure (HTTPS) protocol, and/or a Transport Layer Security (TLS) V3 protocol.

Upon establishing a connection to the SSH server, the user 201 may request access to the device and/or system 202 by providing one or more authentication credentials, such as a login identifier, to the device and/or system 202 via the Secure Shell 210. For example, after the user 201 connects to the SSH server, the SSH server is configured to initialize the pluggable authentication module 212. The pluggable authentication module 212 is configured to initialize the authentication intermediator library 216 via the adaptation layer 214. Then, the authentication intermediator library 216 is configured to establish a connection with the authentication intermediator 203. That is, for example, the authentication intermediator library 216 is configured to authenticate to an application programming interface (API) of the authentication intermediator 203. The pluggable authentication module 212 is configured to request the user 201 to enter his login identifier. The login identifier may include username, phone number, email address, biometric data (e.g., fingerprint, retina, or face recognition), security passcodes or tokens (e.g., one-time passcodes), or any suitable identifier that can verify a user's identity. In certain embodiments, the login identifier may be unique to one user or to a group of users.

After the user enters the login identifier (e.g., username), the pluggable authentication module 212 is configured to use the authentication intermediator library 216 to validate the login identifier. For example, the authentication intermediator library 216, via the authentication intermediator 203, validates the login identifier with the centralized authentication server 204. Once the login identifier is validated, the authentication intermediator 203 is configured to request one or more authentication methods associated with the login identifier from the centralized authentication server 204.

In certain embodiments, after the authentication intermediator 203 obtains the one or more authentication methods associated with the login identifier, the one or more authentication methods may be displayed to the user 201 for selection. The one or more authentication methods may include a one-time password application, an authentication Uniform Resource Locator (URL), a one-time password delivered via email or text message, a multi-factor authentication service, or any suitable authentication method. In certain embodiments, the one or more authentication methods may include one or more primary authentication methods and one or more secondary authentication methods. For example, an administrator (e.g., administrator 205) may determine an authentication method is primary or secondary based on one or more security requirements and/or user preference. In certain embodiments, the one or more primary authentication methods are presented to the user 201 prior to the one or more secondary authentication methods being presented. In one example, the user 201 may select the authentication URL method from the one or more authentication methods displayed on the Secure Shell 210. Upon selecting the authentication URL method, the user 201 may be presented an authentication URL. Then, the user 201 may complete an authentication procedure in accordance with instructions provided at a webpage associated with the URL.

The authentication intermediator library 216 is configured to poll the authentication intermediator 203 to obtain an authentication status associated with the user 201 identified by the login identifier. For example, the authentication credentials (e.g., login identifier and password) provided by the user 201 may be compared with authentication data stored in the centralized authentication server 204. Once the authentication status indicates the user 201 is authenticated, the authentication intermediator 203 is configured to send a session identifier and one or more permissions and/or roles corresponding to the user 201 to the authentication intermediator library 216.

The authentication intermediator library 216, via the adaptation layer 214, is configured to set user permissions on the local authentication server 218 based on one or more permissions and/or roles transmitted by the authentication intermediator 203. Then, the SSH server may spawn the command line interface 222 to initiate a new session based on the session identifier. In the session associated with the session identifier, the local authentication server 218 is configured to authorize the user 201 access to the device and/or system 202 (and/or their resources, services, etc.) in accordance with the one or more permissions and/or roles. That is, for example, the user 201 may take actions in the device and/or system 202 in accordance with the one or more permissions (e.g., read access, write access, delete access, etc.) and/or roles (e.g., “Viewer,” “Administrator,” etc.).

Moreover, the local authentication server 218 is configured to perform a periodic session check for session termination on the centralized authentication server 204 via a Representational State Transfer (REST) framework, a Hypertext Transfer Protocol Secure (HTTPS) protocol, and/or a Transport Layer Security (TLS) V3 protocol. The local authentication server 218 is configured to check periodically for session termination on the authentication intermediator 203 via the authentication intermediator library 216. For example, the session may be remotely terminated by a server-side rule or an administrator.

When the command line interface 222 terminates, the Secure Shell 210 may call the pluggable authentication module 212 to close the session. After the pluggable authentication module 212 closes the session, the pluggable authentication module 212 may notify the authentication intermediator 203, via the authentication intermediator library 216, that the session has ended. Then, the authentication intermediator 203 ends the session on the centralized authentication server 204. In certain embodiments, the administrator 205 may periodically update the centralized authentication server 204 as additional authentication methods become available. In certain embodiments, the command line interface 222 may conduct interprocess communication (IPC) and validate user authorization with the local authentication server 218. In one example, the authentication intermediator 203 is configured to authenticate one or more users to a system including hundreds of devices spread out over a geographical area (e.g., a city) using Single Sign On via Security Assertion Markup Language (SAML). By leveraging the techniques described herein, authentication and permissions may be centrally managed via a dynamic framework that leverages an authentication intermediator to communicate with a centralized authentication server.

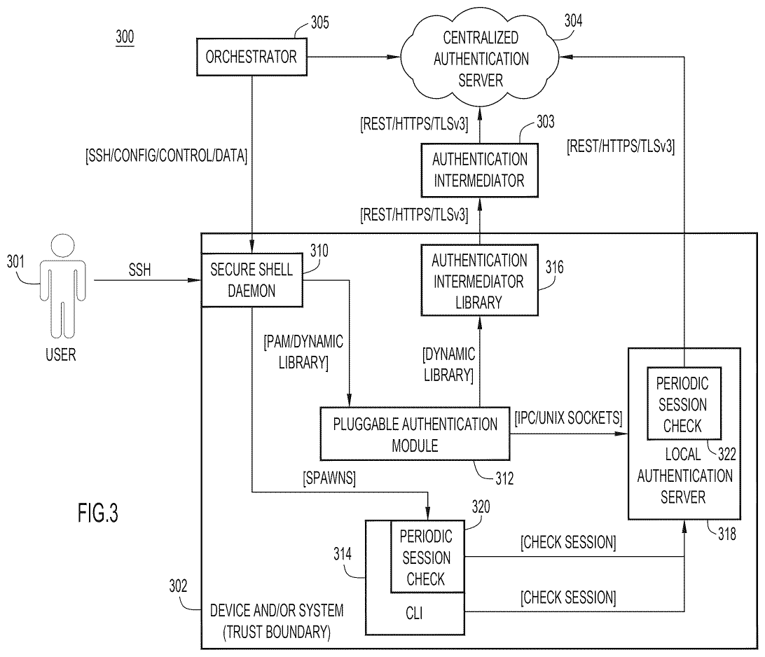

Reference is now made to FIG. 3, for a description of a block diagram illustrating a system 300 for configuring a device and/or system via an orchestrator and authenticating a user to the device and/or system, according to an example embodiment. The system 300 includes a user 301, a device and/or system 302, an authentication intermediator 303, a centralized authentication server 304, and an orchestrator 305. The device and/or system 302 includes Secure Shell Daemon 310 (SSHd), a pluggable authentication module 312 (PAM), a command line interface 314 (CLI), an authentication intermediator library 316, and a local authentication server 318. In certain embodiments, the device and/or system 302 may be considered a trust boundary. The orchestrator 305 is configured to set application programming interface (API) credentials and connectivity configuration for the device and/or system 302. In certain embodiments, the orchestrator 305 may be a controller (e.g., network controller) configured to manage and/or set up one or more devices, applications, and/or services in a network.

The user 301 may connect to a Secure Shell (SSH) server via a Secure Shell. That is, for example, a Secure Shell Daemon 310 (SSHd) is configured to receive a connection request from the user 301. After receiving the connection request, the Secure Shell Daemon 310 is configured to initiate a connection with the pluggable authentication module 312 through a dynamic library. For example, a Linux® PAM, such as “pam_intermediator,” may be called by the Secure Shell Daemon 310. Linux is a registered trademark of Linus Torvalds.

The pluggable authentication module 312 is configured to initialize the authentication intermediator library 316 via a dynamic library. Then, the authentication intermediator library 316 is configured to connect to the authentication intermediator 303. In certain embodiments, the authentication intermediator library 316 (e.g., “libauthentication”) may be an intermediation layer between the authentication intermediator 303 and the local authentication server 318.

In certain embodiments, the centralized authentication server 304 may be a centralized Authentication, Authorization and Accounting/Auditing (AAA) server configured to store one or more authentication methods associated with one or more users. In certain embodiments, the local authentication server 318 may be a local Authentication, Authorization and Accounting/Auditing (AAA) server configured to authorize user access to the device and/or system 202 based on user permissions and track user access information (e.g., login timestamp, session duration, etc.). Moreover, in certain embodiments, the authentication intermediator library 316 may interface with the authentication intermediator 303 via a Representational State Transfer (REST) framework, a Hypertext Transfer Protocol Secure (HTTPS) protocol, and/or a Transport Layer Security (TLS) V3 protocol. In certain embodiments, the authentication intermediator 303 may interface with the centralized authentication server 304 via the REST framework, the HTTPS protocol, and/or the TLS V3 protocol.

After the authentication intermediator library 316 establishes connection with the authentication intermediator 303, the authentication intermediator library 316 is configured to authenticate to an application programming interface (API) of the authentication intermediator 303. The pluggable authentication module 312 is configured to request the user 301 to enter his login identifier. The login identifier may include username, phone number, email address, biometric data (e.g., fingerprint, retina, or face recognition), security passcodes or tokens (e.g., one-time passcodes), or any suitable identifier that can verify a user's identity. In certain embodiments, the login identifier may be unique to one user or to a group of users.

After the user enters the login identifier (e.g., username), the pluggable authentication module 312 is configured to use the authentication intermediator library 316 to validate the login identifier. For example, the authentication intermediator library 316, via the authentication intermediator 303, validates the login identifier with the centralized authentication server 304. Once the login identifier is validated, the authentication intermediator 303 is configured to request one or more authentication methods associated with the login identifier from the centralized authentication server 304.

In certain embodiments, after the authentication intermediator 303 obtains the one or more authentication methods associated with the login identifier, the one or more authentication methods may be displayed to the user 301 for selection. The one or more authentication methods may include a one-time password application, an authentication Uniform Resource Locator (URL), a one-time password delivered via email or text message, a multi-factor authentication service, or any suitable authentication method. In certain embodiments, the one or more authentication methods may include one or more primary authentication methods and one or more secondary authentication methods. For example, an administrator may determine an authentication method is primary or secondary based on security requirements and/or user preference. In certain embodiments, the one or more primary authentication methods are presented to the user 301 prior to the one or more secondary authentication methods being presented.

In one example, the user 301 may select the authentication URL method from the one or more authentication methods displayed on an interface (e.g., Secure Shell, graphical user interface, etc.). Upon selecting the authentication URL method, the user 301 may be presented an authentication URL. Then, the user 301 may complete the authentication procedure in accordance with instructions provided at a webpage associated with the URL. Moreover, in certain embodiments, the authentication intermediator library 316 may be configured to create and provide a generic representation of the one or more authentication methods retrieved from the centralized authentication server 304.

The authentication intermediator library 316 is configured to poll the authentication intermediator 303 to obtain an authentication status associated with the user 301. For example, the authentication credentials (e.g., login identifier and password) provided by the user 301 may be compared with authentication data stored in the centralized authentication server 304. Once the authentication status indicates the user 301 is authenticated, the authentication intermediator 303 is configured to send a session identifier and one or more permissions and/or roles corresponding to the user 301 to the authentication intermediator library 316.

The authentication intermediator library 316 is configured to set user permissions on the local authentication server 318 based on one or more permissions and/or roles transmitted by the authentication intermediator 303. Then, the Secure Shell Daemon 310 is configured to spawn the command line interface 314 to initiate a new session based on the session identifier. In the session associated with the session identifier, the local authentication server 318 is configured to authorize the user 301 access to the device and/or system 302 (and/or their resources, services, etc.) in accordance with the one or more permissions and/or roles. That is, for example, the user 301 may take actions in the device and/or system 302 in accordance with the one or more permissions (e.g., read access, write access, delete access, etc.) and/or roles (e.g., “Viewer,” “Administrator,” etc.).

The command line interface 314 is configured to perform a periodic session check 320 on the local authentication server 318. Moreover, the local authentication server 318 is configured to perform a periodic session check 322 on the centralized authentication server 304 via a Representational State Transfer (REST) framework, a Hypertext Transfer Protocol Secure (HTTPS) protocol, and/or a Transport Layer Security (TLS) V3 protocol. The local authentication server 318 is configured to check periodically for session termination on the authentication intermediator 303 via the authentication intermediator library 316.

When the command line interface 314 terminates, the SSH is configured to initiate the pluggable authentication module 312 to close the session identified by the session identifier. After the pluggable authentication module 312 closes the session, the pluggable authentication module 312, via the authentication intermediator library 316, notifies the authentication intermediator 303 that the session has ended. Then, the authentication intermediator 303 ends the session on the centralized authentication server 304. In certain embodiments, an administrator may periodically update the centralized authentication server 304 as additional authentication methods become available. In certain embodiments, the command line interface 314 may conduct interprocess communication (IPC) via UNIX® Sockets and validate user authorization with the local authentication server 318. UNIX is a registered trademark of The Open Group.

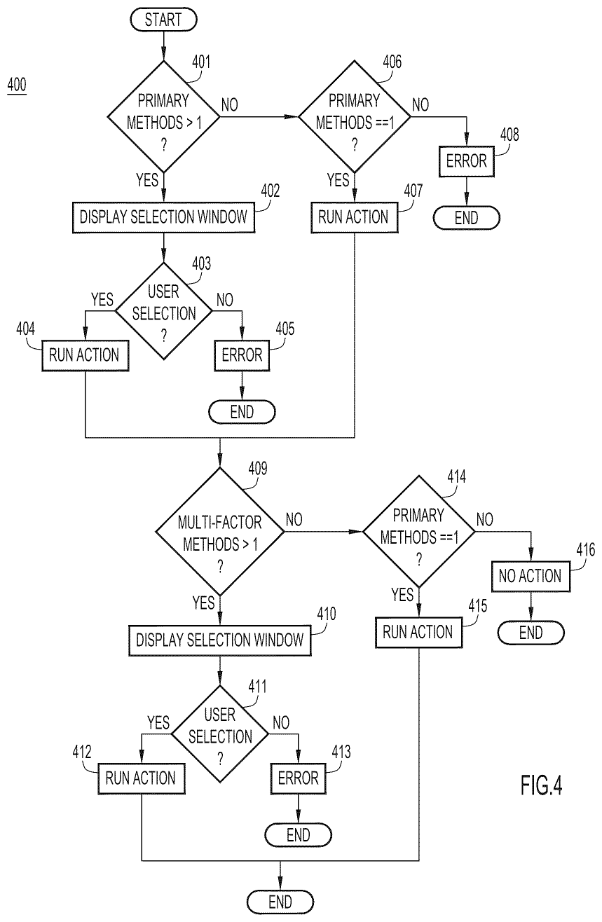

Reference is now made to FIG. 4, for a description of a method 400 for selecting one or more authentication methods, according to an example embodiment. As described above, the one or more authentication methods associated with a user (e.g., identified by a login identifier) may be obtained from a centralized authentication server. In certain embodiments, the one or more authentication methods may include one or more primary authentication methods and/or one or more secondary authentication methods. For example, an administrator may determine an authentication method is primary or secondary based on one or more security requirements and/or user preference. The one or more authentication methods may be displayed to the user for selection, where the one or more primary authentication methods are presented to the user for selection prior to the one or more secondary authentication methods being presented. In certain embodiments, an authentication intermediator may send the one or more authentication methods to an authentication intermediator library, and additional authentication methods may be retrieved from a centralized authentication server. Thus, the authentication intermediator may be leveraged to ensure a device and/or system is forward-compatible with newly developed and/or required authentication methods.

The method 400 for selecting one or more authentication methods begins at 401, where a determination is made of whether there is more than one primary method (e.g., primary authentication method) associated with the user. If there is more than one primary method, a selection menu is displayed at 402. If the user selects one of the primary methods at 403, the selected primary method is executed at 404. If the user does not make a selection at 403, then an error is returned and/or displayed to the user at 405 and the method 400 ends.

However, if it is determined that there is no more than one primary method at 401, then the method 400 is configured to determine whether there is exactly one primary method at 406. If there is exactly one primary method, then that primary method is executed at 407. However, if there is not exactly one primary method, then an error is returned and/or displayed to the user at 408 and the method 400 ends.

In the case where the primary method is executed (e.g., at operation 404 or operation 407), the method 400 is configured to determine whether there is more than one multi-factor method (e.g., multi-factor authentication methods) at 409. If it is determined that there is more than one multi-factor method at 409, then a selection menu is displayed at 410. If the user selects one of the multi-factor methods at 411, the selected multi-factor method is executed at 412 and the method 400 ends. If the user does not make a selection at 411, then an error is returned and/or displayed to the user at 413 and the method 400 ends.

However, if it is determined that there is no more than one multi-factor method at 409, then the method 400 is configured to determine whether there is exactly one multi-factor method at 414. If there is exactly one primary method, then the primary method is executed at 415. However, if there is not exactly one primary method, then no action is taken at 416.

In certain embodiments, the one or more authentication methods may be sent by an authentication intermediator. An example authentication method may be implemented as follows:

```
{
  “userMessage”: “Authentication service”,
  “primary”: {
        “userMessage”: “”,
        “methods”: [{
          “name”: “password”,
          “userPrompt”: “Password: ”,
          “userMessage”: “”,
          “promptEchoOff”: true,
          “waitForUserInput”: true,
          “timeout”: 3600
          }]
    },
    “multiFactors”: {
        “userMessage”: “Please select second authentication factor”,
        “menuPrompt”: “Please select second factor: ”,
        “methods”: [{
        “fieldName”: “appOtp”
        “name”: “ApplicationOTP”,
        “userPrompt”: “Application OTP: ”,
        “userMessage”: “”,
        “waitForUserInput”: true,
        “timeout”: 3600
      }, {
        “fieldName”: “validURL”
        “name”: “Validation URL”,
        “userPrompt”: “Enter Code: ”,
        “userMessage”: “Please visit:
        https://example.com/4973ohfkjhdfkahdaj”,
        “waitForUserInput”: true,
        “timeout”: 3600
      }, {
        “fieldName”: “EmailOtp”
        “name”: “Email OTP”,
        “userPrompt”: “Enter Code: ”,
        “userMessage”: “”,
        “request”: true,
        “waitForUserInput”: true,
        “timeout”: 3600
      }]
  }
}
```

The following is a table providing description of fields in an exemplary implementation of an authentication method:

| Field | Description |
|---|---|
| primary | Primary authentication methods. |
| multiFactors | Secondary authentication methods. |
| userMessage | Message to display to the user for each section. |
| menuPrompt | User prompt to display when a menu is displayed. |
| promptEchoOff | Disable echo of user input. Should be used for |
| | password and other fields that require visual privacy. |
| methods | Array of authentication methods to offer to the user. |
| fieldName | Name of the authentication factor when requesting user |
| | authentication. |
| name | Name of the authentication method when presented to |
| | the user in the selection menu. |
| userPrompt | Text to use as a prompt for the user. |
| request | This method requires a server side trigger. |
| waitForUserInput | Wait for user input. |
| timeout | Maximum time to wait for user input. |

In certain embodiments, when requesting user authentication, an array of authentication factors may be sent to the authentication intermediator. This array may be used to add flexibility by allowing any permutations of factors. A sample array of authentication factors is provided below:

```
{
  “username”: “myuser@example.com”,
  “factors”: [
    {
      “name”: “password”,
      “value”: “123456”
    },
    {
      “name”: “ApplicationOPT”,
      “value”: “123456”
    },
    {
      “name”: “emailOTP”,
      “trigger”: true
    }
  ]
}
```

As described above, upon authenticating the user via the one or more authentication methods, the authentication intermediator is configured to determine one or more permissions and/or roles associated with the user and transmit the one or more permissions and/or roles to a local authentication server in the device and/or system. That is, for example, when the user is authenticated, the authentication intermediator returns an array of permissions that may be used by the local authentication server to grant access to the authenticated user. A sample array of permissions is provided as follows:

```
{
  “sessionId”: “jsfhfiyw89547403298402840238”,
  “SessionToken”: “94303984098340938404329843098”,
  “expiration”: 3600,
  “permissions”: [“Admin”, “Management”, “Config”]
}
```

A table including examples of permissions is provided as follows:

| ACL | Loopback | Virtual Network |
|---|---|---|
| Alarms | Management | Virtual-connection |
| CFM | Policies | Y.1564 |
| Config | RFC-2544 | All-add |
| Discovery | Remote-Device-Mgnt | All-edit |
| Feature-Suite | SAT-Protocol | All-enable |
| Filters | SAT-reporting | |
| Firmware | Security-Key | |
| Firewall | Sessions | |
| History | Traffic | |
| Log | Users | |

The one or more authentication methods mays include single-factor authentication (e.g., authentication via a password), multi-factor authentication (e.g., authentication via a password and a one-time password/code), single sign-on (SSO), biometric authentication, token authentication, and any suitable authentication method. In certain embodiments, each of the one or more authentication methods may include a plurality of operations. For example, the plurality of operations may include prompting the user for input (e.g., login identifier and/or password), triggering a server-side action, polling for authentication result, and requesting authentication validation.

For example, the user may be prompted for input (e.g., login identifier and/or password) via an interface (e.g., website or SSH). The prompt for input may be associated with a maximum input time during which the user may provide input. The operation of prompting the user for input may be applicable in password authentication and one-time password (OTP) authentication, such as email OTP and uniform resource locator (URL) OTP.

After the user provides the input (e.g., login identifier and/or password), a server-side action may be triggered when needed (e.g., triggering an email of one-time password). This operation may cause an authentication intermediator library to call AuthenticateUser( ) with the authentication factor set as a trigger. The operation of triggering server-side action may be applicable in email OTP and Short Message Service (SMS) OTP.

When the user is directed to the authentication intermediator to complete the authentication, the authentication intermediator library is configured to poll the authentication intermediator to determine an outcome of the authentication process. This operation may be applicable in Security Assertion Markup Language (SAML), Authentication URL, Single Sign On (SSO) authentication, two-factor authentication service, etc. In embodiments where the polling operation is not applicable, one or more authentications factors may be collected and sent to the authentication intermediator for validation. The authentication intermediator may send one or more authentication methods to the authentication intermediator library. In certain embodiments, the one or more authentication methods are grouped into one or more primary authentication methods and/or one or more secondary authentication methods (e.g., multi-factor methods) as described above.

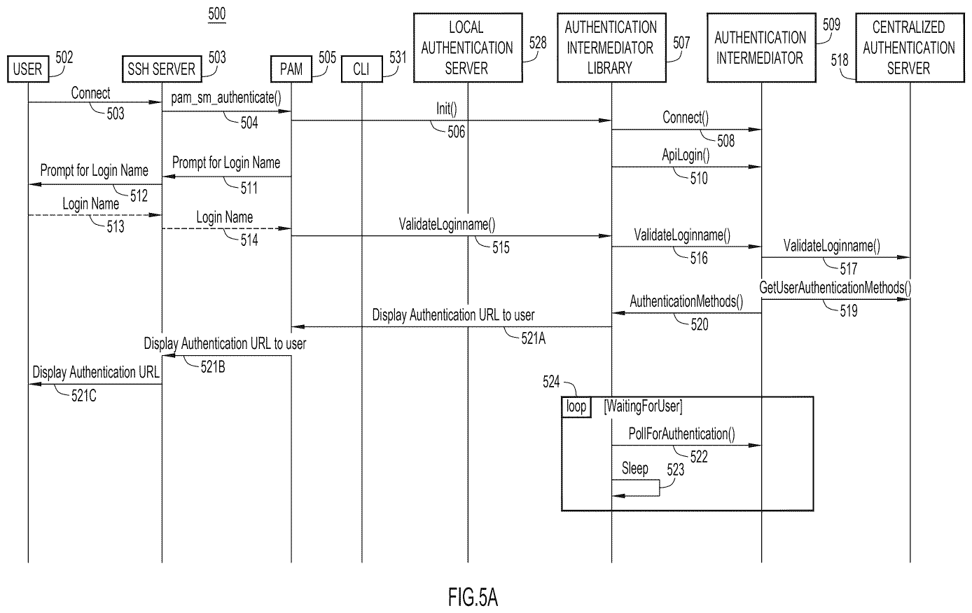

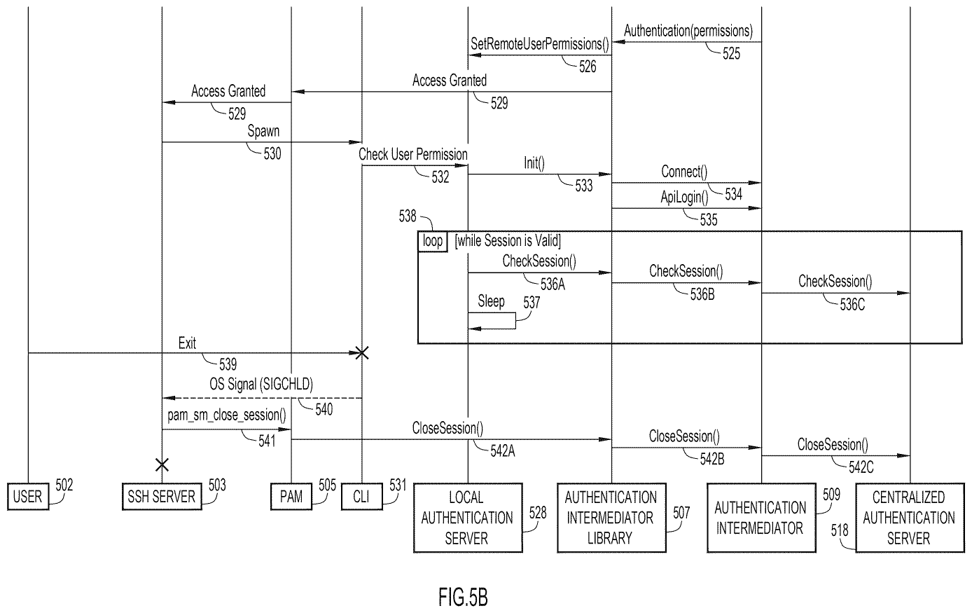

Reference is now made to FIG. 5A and FIG. 5B, for a description of an operational sequence diagram illustrating a method 500 for authenticating a user via an authentication intermediator, according to an example embodiment. The method 500 begins at 501, where a user 502 initiates a connection with a Secure Shell (SSH) server 503. Then, at 504, the SSH server 503 initiates a pluggable authentication module 505 (PAM) via a function (e.g., “pam_sm_authenticate( )”). At 506, the pluggable authentication module 505 initializes an authentication intermediator library 507. Then, at 508, the authentication intermediator library 507 establishes a connection with a authentication intermediator 509. At 510, the authentication intermediator library 507 authenticates to an application programming interface (API) of the authentication intermediator 509 via a function (e.g., “ApiLogin( )”). Then, at 511, the pluggable authentication module 505 prompts the SSH server 503 for a login name. At 512, the SSH server 503 prompts the user 502 to enter his login name (or any login identifier). After the user 502 enters his login name, the login name is transmitted to the SSH server 503 at 513. Then, at 514, the login name is transmitted from the SSH server 503 to the pluggable authentication module 505.

At 515, the pluggable authentication module 505 validates the login name with the authentication intermediator library 507. At 516, the authentication intermediator library 507 validates the login name with the authentication intermediator 509. At 517, the authentication intermediator 509 validates the login name with a centralized authentication server 518. Then, at 519, the authentication intermediator 509 requests the one or more authentication methods associated with the user (identified by the login identifier) from the centralized authentication server 518. At 520, the authentication intermediator 509 transmits the one or more authentication methods associated with the user to the authentication intermediator library 507. At 521A, the authentication intermediator library 507 makes a call to display an authentication URL to the user 502 to the pluggable authentication module 505. At 521B, the pluggable authentication module 505 makes a call to display an authentication URL to the user 502 to the SSH server 503. At 521C, the SSH server 503 displays the authentication URL to the user 502. In certain embodiments, the user 502 connects to the URL and completes the authentication process in accordance with prompts and/or instructions provided in the webpage associated with the URL. Then, at 522, the authentication intermediator library 507 polls the authentication intermediator 509 to obtain an authentication status of the user 502 (e.g., authenticated or unauthenticated). At 523, the authentication intermediator library 507 may remain in “sleep” mode while waiting for the user 502 to authenticate. Operations 522 and 523 may proceed iteratively in a loop 524 until the authentication status is obtained.

With continued reference to FIG. 5A, FIG. 5B continues to illustrate the method 500 for authenticating a user via an authentication intermediator, according to an example embodiment. Once the user is authenticated, the authentication intermediator 509 transmits a session identifier and one or more permissions and/or roles to the authentication intermediator library 507 at 525. At 526, based on the one or more permissions and/or roles provided by the authentication intermediator 509, the authentication intermediator library 507 sets user permissions for the user 502 (e.g., a remote user) on a local authentication server 528. Then, at 529, the local authentication server 528 provides an indication to the SSH server 503 that the user 502 is granted access based on the one or more permissions and/or roles. At 530, the SSH server 503 spawns a command line interface 531 (CLI).

At 532, the command line interface 531 checks user permission with the local authentication server 528. At 533, the local authentication server 528 initializes the authentication intermediator library 507. Then, at 534, the authentication intermediator library 507 connects with the authentication intermediator 509 to obtain user permissions. At 535, the authentication intermediator library 507 authenticates to the API of the authentication intermediator 509 via a function (e.g., “ApiLogin( )”). While the session associated with the session identifier is valid, the local authentication server 528 periodically makes a check session call to the authentication intermediator library 507 at 536A, the authentication intermediator library 507 periodically makes a check session call to the authentication intermediator 509 at 536B, and the authentication intermediator 509 periodically makes a check session call to the centralized authentication server 518 at 536C. The check session calls are configured to check for session termination on the centralized authentication server 518. At 537, the local authentication server 528 may remain in “sleep” mode after checking for session termination while the session remains valid. Operations 536A-C and 537 may proceed iteratively in a loop 538 while the session remains valid.

At 539, the user 502 exits the command line interface 531. At 540, the command line interface 531 terminates and sends an operating system (OS) signal (e.g., “SIGCHLD”) to the SSH server 503. Then, at 541, the SSH server 503 calls the pluggable authentication module 505 to close the session. At 542A, the pluggable authentication module 505 makes a call to the authentication intermediator library 507 to close the session. At 542B, the authentication intermediator library 507 makes a call to the authentication intermediator 509 to close the session. At 542C, the authentication intermediator 509 makes a call to the centralized authentication server 518 to close the session. In certain embodiments, an administrator may periodically update the centralized authentication server 518 as additional authentication methods are added based on one or more security requirements and/or user preferences.

In certain embodiments, even if a user (e.g., user 502) is not a valid user, the user's interactions with the authentication process should be the same as if the user was a valid user to avoid confirming the validity of the login name, thereby providing enhanced privacy protection. In certain embodiments, the API of the authentication intermediator may return a list of authentication methods and any authentication failures. An example implementation of validating a user and returning a list of authentication requirements is provided as follows:

```
URL
POST /<PREFIX>/ValidateUserLogin
Header
Content-Type: application/json
Accept: application/json
Authorization: barer <ACCESS TOKEN>
Body
{
  “username”: “myuser@example.com”
}
Reply
{
  “userMessage”: “Legal notice”,
  “primary”: {
    “userMessage”: “”,
    “methods”: [{
      “name”: “password”,
      “userPrompt”: “Password: ”,
      “promptEchoOff”: true,
      “userMessage”: “”,
      “waitForUserInput”: true,
      “timeout”: 3600
      }]
  },
  “multiFactors”: {
    “userMessage”: “”,
    “methods”: [{
    “fieldName”: “appOtp”
    “name”: “ApplicationOTP”,
    “required”: false,
    “userPrompt”: “Application OTP: ”,
    “userMessage”: “”,
    “waitForUserInput”: true,
    “timeout”: 3600
    }, {
    “fieldName”: “validURL”
    “name”: “Validation URL”,
    “userPrompt”: “Enter Code: ”,
    “userMessage”: “Please visit:
    https://example.com/4973ohfkjhdfkahdaj”,
    “waitForUserInput”: true,
    “timeout”: 3600
    }, {
    “fieldName”: “EmailOtp”
    “name”: “Email OTP”,
    “userPrompt”: “Enter Code: ”,
    “userMessage”: “”,
    “request”: true,
    “waitForUserInput”: true,
    “timeout”: 3600
    }, {
    “name”: “Duo Push”,
    “userPrompt”: “”,
    “userMessage”: “Please follow the link to complete
    authentication:\nhttps://
    mysaaa.example.com/sso/c8155a2d-f21e-4944-af02-bccd416834b0”,
    “pollForAuthentication”: true,
    “sessionId”: “c8155a2d-f21e-4944-af02-bccd416834b0”
    “timeout”: 3600
    }]
  }
}
```

An example implementation of an API call to poll for server-side interaction is provided as follows:

```
URL
GET <PREFIX>/PollForAuthentication/<AuthenticationId>
Header
Content-Type: application/json
Accept: application/json
Authorization: barer <ACCESS TOKEN>
Reply
{
  ″sessionId″: ″jsfhfiyw89547403298402840238″,
  ″sessionToken″: ″94303984098340938404329843098″,
  ″expiration ″: 3600,
  ″permissions″: [
    “Admin″,
    ″Management″,
    “Firewall”]
}
```

An example implementation of an AuthenticateUser method is provided as follows:

```
URL
POST /<PREFIX>/AuthenticateUser
Header
Content-Type: application/json
Accept: application/json
Authorization: barer <ACCESS TOKEN>
Body
{
  “username”: “myuser@example.com”,
  “factors”: [
  {
    “name”: “password”,
    “value”: “123456”
  },
  {
    “name”: “ApplicationOPT”,
    “value”: “123456”
  },
  {
    “name”: “eOTP”,
    “trigger”: true
  }
]
}
Reply
{
  “sessionId”: “jsfhfiyw89547403298402840238”,
  “sessionToken”: “94303984098340938404329843098”,
  “expiration”: 3600,
  “permissions”: [
    “Admin”,
    “Management”,
    “Firewall”
  ]
}
```

An example implementation of a CheckSession method is provided as follows:

```
URL
GET /<PREFIX>/CheckSession/<sessionId>
Header
Content-Type: application/json
Accept: application/json
Authorization: barer <ACCESS TOKEN>
Reply
{
  “sessionId”: “jsfhfiyw89547403298402840238”,
  “expiration”: 2400,
}
```

An example implementation of a CloseSession method is provided as follows:

```
URL
POST /<PREFIX>/CloseSession
Header
Content-Type: application/json
Accept: application/json
Authorization: barer <ACCESS TOKEN>
Body
{
  “sessionId”: “jsfhfiyw89547403298402840238”,
  “sessionToken”: “94303984098340938404329843098”
}
Reply
{
  “error”: { }
}
```

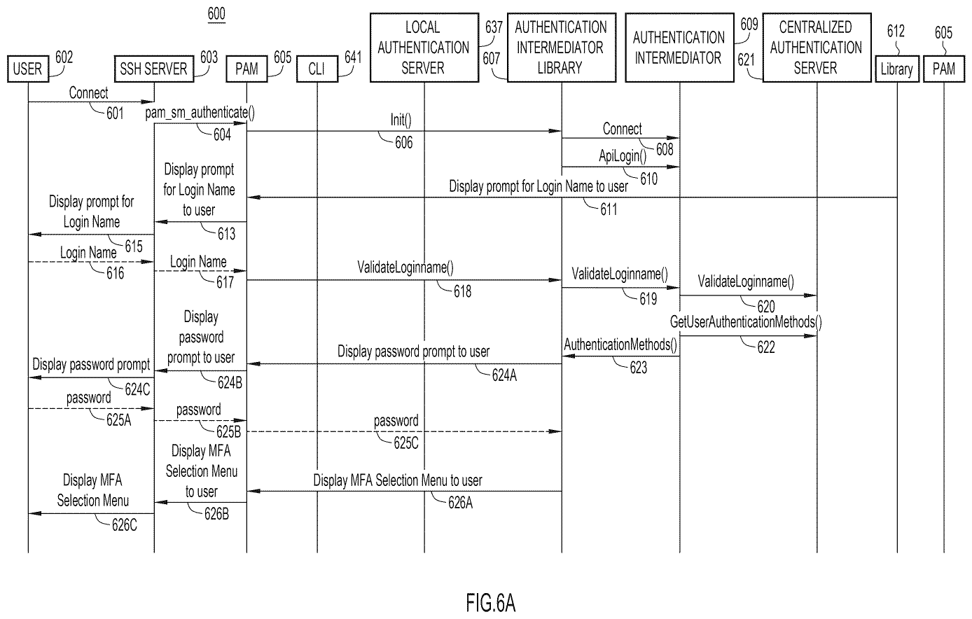

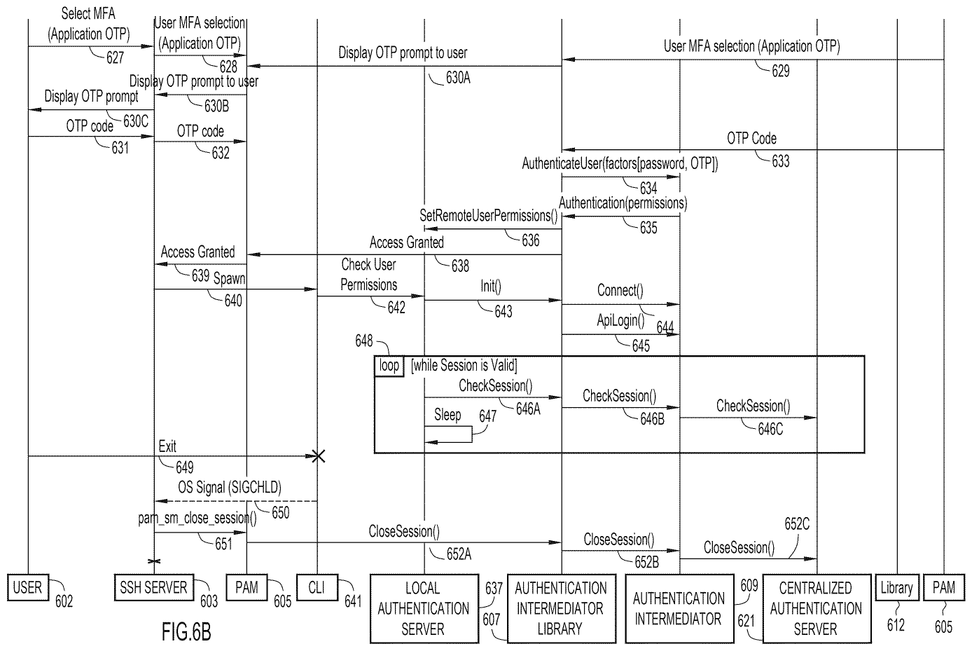

Reference is now made to FIG. 6A and FIG. 6B, for a description of an operational sequence diagram illustrating a method 600 for authenticating a user via an authentication intermediator using multi-factor authentication, according to an example embodiment. The method 600 begins at 601, where a user 602 initiates a connection with a Secure Shell (SSH) server 603. Then, at 604, the SSH server 603 initiates a pluggable authentication module 605 (PAM) via a function (e.g., “pam_sm_authenticate( )”). At 606, the pluggable authentication module 605 initializes an authentication intermediator library 607. Then, at 608, the authentication intermediator library 607 establishes a connection with an authentication intermediator 609. At 610, the authentication intermediator library 607 authenticates to an application programming interface (API) of the authentication intermediator 609 via a function (e.g., “ApiLogin( )”).

Then, at 611, a library 612 makes a call to the pluggable authentication module 605 to display a prompt for login name to the user 602. At 613, the pluggable authentication module 605 makes a call to the SSH server 603 to display the prompt for login name to the user 602. At 615, the SSH server 603 displays the prompt for login name to the user 602. After the user enters his login name, the login name is provided to the SSH server 603 at 616. Then, at 617, the SSH server 603 provides the login name to the pluggable authentication module 605. At 618, the pluggable authentication module 605 validates the login name with the authentication intermediator library 607. At 619, the authentication intermediator library 607 validates the login name with the authentication intermediator 609. At 620, the authentication intermediator 609 validates the login name with a centralized authentication server 621. Then, at 622, the authentication intermediator 609 requests the one or more authentication methods associated with the user (identified by the login identifier) from the centralized authentication server 621. At 623, the authentication intermediator 609 provides the one or more authentication methods associated with the user to the authentication intermediator library 607.

At 624A, the authentication intermediator library 607 makes a call to display a password prompt to the user 602 to the pluggable authentication module 605. At 624B, the pluggable authentication module 605 makes a call to display a password prompt to the user 602 to the SSH server 603. At 624C, the SSH server 603 displays the password prompt to the user 602. Then, at 625A, the user 602 provides as input a password to the SSH server 603. At 625B, the SSH server 603 provides the password to the pluggable authentication module 605. At 625C, the pluggable authentication module 605 provides the password to the authentication intermediator library 607. At 626A, the authentication intermediator library 607 makes a call to display a multi-factor authentication (MFA) selection menu to the user 602 to the pluggable authentication module 605. At 626B, the pluggable authentication module 605 makes a call to display the MFA selection menu to the user 602 to the SSH server 603. At 626C, the SSH server 603 displays the MFA selection menu to the user 602.

With continued reference to FIG. 6A, FIG. 6B continues to illustrate the method 600 for authenticating a user via an authentication intermediator using multi-factor authentication, according to an example embodiment. At 627, the user 602 selects an MFA method. For example, the user 602 may select an application one-time password OTP as the MFA method. At 628, the SSH server 603 provides the MFA method selection (e.g., application OTP) to the pluggable authentication module 605. At 629, the pluggable authentication module 605 provides the user MFA method selection (e.g., application OTP) to the authentication intermediator library 607. At 630A, the authentication intermediator library 607 makes a call to display an OTP prompt to the user 602 to the pluggable authentication module 605. At 630B, the pluggable authentication module 605 makes a call to display the OTP prompt to the user 602 to the SSH server 603. At 630C, the SSH server 603 displays the OTP prompt to the user 602.

At 631, in response to the OTP prompt, the user 602 provides an OTP code to the SSH server 603. At 632, the SSH server 603 provides the OTP code to the pluggable authentication module 605. At 633, the pluggable authentication module 605 provides the OTP code to the authentication intermediator library 607. Then, at 634, the authentication intermediator library 607 authenticates the user based on the password and OTP provided by the user 602 for multi-factor authentication and provides an authentication status to the authentication intermediator 609. Once the user is authenticated, at 635, the authentication intermediator 609 provides a session identifier and one or more permissions and/or roles to the authentication intermediator library 607. At 636, based on the one or more permissions and/or roles provided by the authentication intermediator 609, the authentication intermediator library 607 sets user permissions for the user 602 (e.g., a remote user) on a local authentication server 637. Then, at 638, the local authentication server 637 provides an indication to the pluggable authentication module 605 that the user 602 is granted access based on the one or more permissions and/or roles. Then, at 639, the pluggable authentication module 605 provides an indication to the SSH server 603 that the user 602 is granted access. At 640, the SSH server 603 spawns a command line interface 641 (CLI).

At 642, the command line interface 641 checks user permission with the local authentication server 637. At 643, the local authentication server 637 initializes the authentication intermediator library 607. Then, at 644, the authentication intermediator library 607 connects with the authentication intermediator 609 to obtain user permissions. At 645, the authentication intermediator library 607 authenticates to the API of the authentication intermediator 609 via a function (e.g., “ApiLogin( )”). While the session associated with the session identifier is valid, the local authentication server 637 periodically makes a check session call to the authentication intermediator library 607 at 646A, the authentication intermediator library 607 periodically makes a check session call to the authentication intermediator 609 at 646B, and the authentication intermediator 609 periodically makes a check session call to the centralized authentication server 621 at 646C. The check session calls are configured to check for session termination on the centralized authentication server 621. At 647, the local authentication server 637 may remain in “sleep” mode after checking for session termination while the session remains valid. Operations 646A-C and 647 may proceed iteratively in a loop 648 while the session remains valid.

At 649, the user 602 exits the command line interface 641. At 650, the command line interface 641 terminates and sends an operating system (OS) signal (e.g., “SIGCHLD”) to the SSH server 603. Then, at 651, the SSH server 603 calls the pluggable authentication module 605 to close the session. At 652A, the pluggable authentication module 605 makes a call to the authentication intermediator library 607 to close the session. At 652B, the authentication intermediator library 607 makes a call to the authentication intermediator 609 to close the session. At 652C, the authentication intermediator 609 makes a call to the centralized authentication server 621 to close the session. In certain embodiments, an administrator may periodically update the centralized authentication server 621 as additional authentication methods are added based on one or more security requirements and/or user preferences.

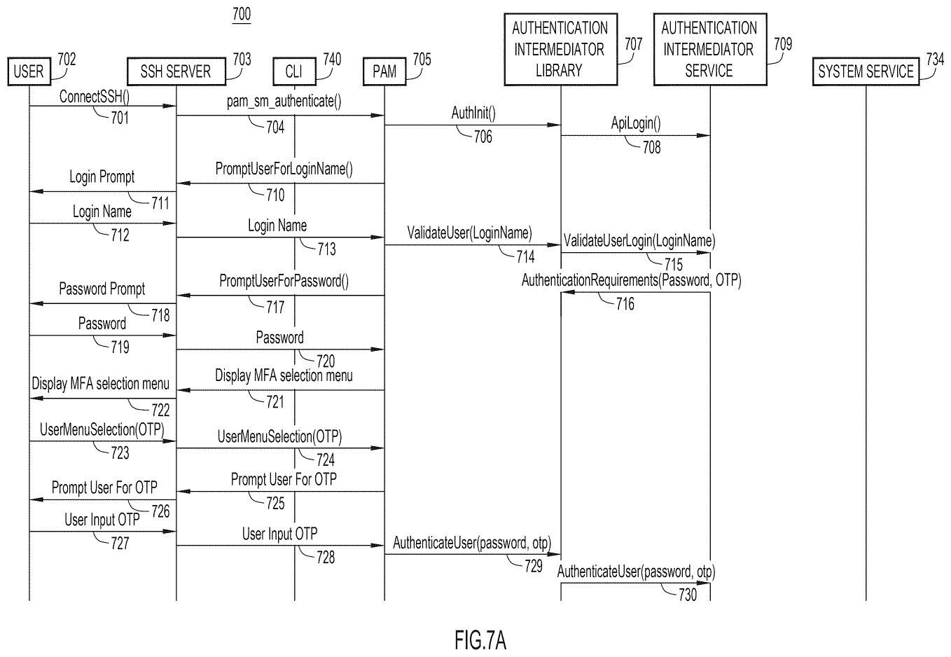

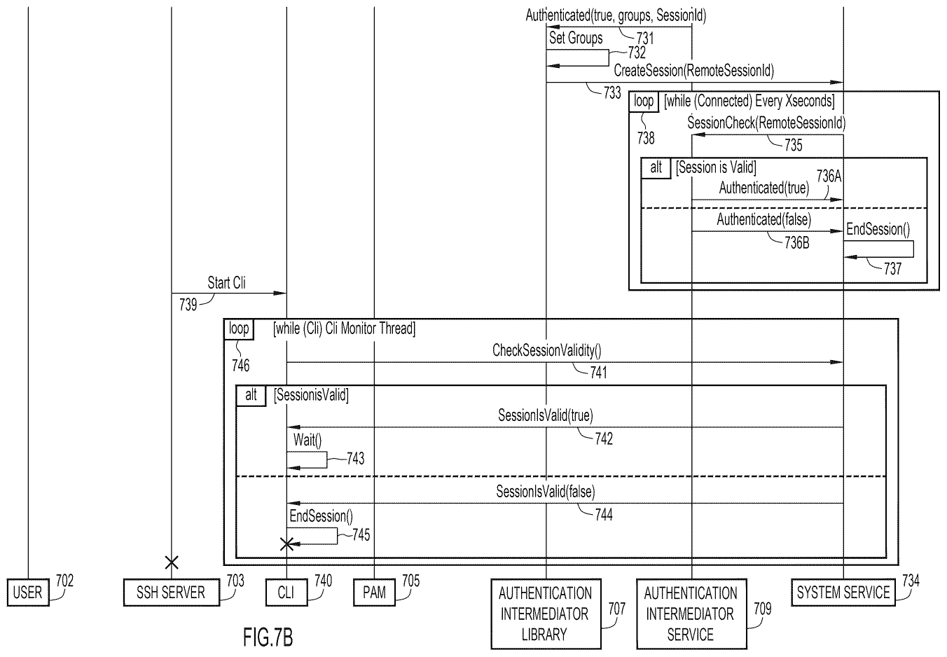

Reference is now made to FIG. 7A and FIG. 7B, for a description of an operational sequence diagram illustrating a method 700 for authenticating a user via an authentication intermediator using multi-factor authentication, according to an example embodiment. The method 700 begins at 701, where a user 702 initiates a connection with a Secure Shell (SSH) server 703. Then, at 704, the SSH server 703 initiates a pluggable authentication module 705 (PAM) via a function (e.g., “pam_sm_authenticate( )”). At 706, the pluggable authentication module 705 initiates authentication with an authentication intermediator library 707 via a function (e.g., “Authinit( )”). At 708, the authentication intermediator library 707 authenticates to an application programming interface (API) of an authentication intermediator service 709 via a function (e.g., “ApiLogin( )”).

At 710, the pluggable authentication module 705 makes a call to the SSH server 703 to prompt the user 702 for a login name. At 711, the SSH server 703 displays the prompt for login name to the user 702. After the user enters his login name, the login name is provided to the SSH server 703 at 712. Then, at 713, the SSH server 703 provides the login name to the pluggable authentication module 705. At 714, the pluggable authentication module 705 validates the login name with the authentication intermediator library 707. At 715, the authentication intermediator library 707 validates the login name with the authentication intermediator service 709. At 716, the authentication intermediator service 709 provides authentication requirements, including password and one-time password (OTP), to the authentication intermediator library 707.

Then, at 717, based on the authentication requirements, the pluggable authentication module 705 makes a call to the SSH server 703 to prompt the user 702 to provide password. At 718, the SSH server 703 prompts the user 702 to provide the password. At 719, the user 702 provides the password to the SSH server 703. At 720, the SSH server 703 provides the password to the pluggable authentication module 705. At 721, the pluggable authentication module 705 makes a call to display the a multi-factor (MFA) selection menu to the user 702 to the SSH server 703. At 722, the SSH server 703 displays the MFA selection menu to the user 702.

At 723, the user 702 selects an MFA method. For example, the user 702 may select an application one-time password (OTP) as the MFA method. At 724, the SSH server 703 provides the MFA method selection (e.g., application OTP) to the pluggable authentication module 705. At 725, the pluggable authentication module 705 makes a call to the SSH server 703 to prompt the user 702 for OTP. At 726, the SSH server 703 prompts to the user 702 for OTP. Then, at 727, the user 702 provide as input the OTP to the SSH server 703. At 728, the SSH server 703 provides the OTP to the pluggable authentication module 705. Then, at 729, the pluggable authentication module 705 makes a call to the authentication intermediator library 707 to authenticate the user 702 based on the password and the OTP. At 730, the authentication intermediator library 707 makes a call to the authentication intermediator service 709 to authenticate the user 702 based on the password and the OTP.

With continued reference to FIG. 7A, FIG. 7B continues to illustrate the method 700 for authenticating a user via an authentication intermediator using multi-factor authentication, according to an example embodiment. Once the user authenticates, at 731, the authentication intermediator service 709 sends to the authentication intermediator library 707 an authentication status (e.g., authenticated==True), one or more user permission groups, and a new session identifier. Then, at 732, the authentication intermediator library 707 sets the one or more user permission groups. At 733, the authentication intermediator library 707 creates a remote session based on the new session identifier (e.g., remote session identifier) at a system service 734.

Then, at 735, the system service 734 periodically checks (e.g., every x seconds) for session termination while the user 702 is connected to the system service 734. While the session remains valid, the authentication intermediator service 709 may authenticate the user 702 at 736A and 736B. If authentication fails (authenticated=false), then the system service 734 ends the session at 737. The operations 735, 736A-B, and 737 may proceed iteratively in a loop 738 until a stopping criterion is met (e.g., the session ends).

At 739, the SSH server 703 initiates a command line interface 740 (CLI). At 741, the command line interface 740 makes a call to the system service 734 to check the validity of a session. In response, the system service 734 may report that the session is valid at 742. If the session is valid, then the command line interface 740 waits for the session at 743. However, if the system service 734 reports that the session is not valid at 744, then the session may be ended at 745. The operations 741, 742, 743, 744, and 745 may proceed iteratively in a loop 746 while a CLI monitor thread remains active.

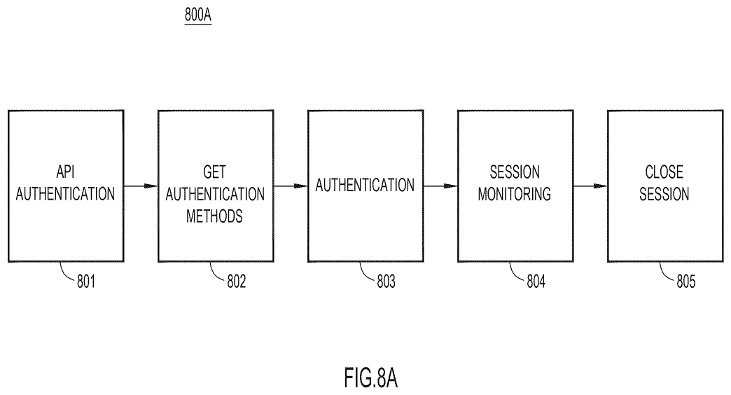

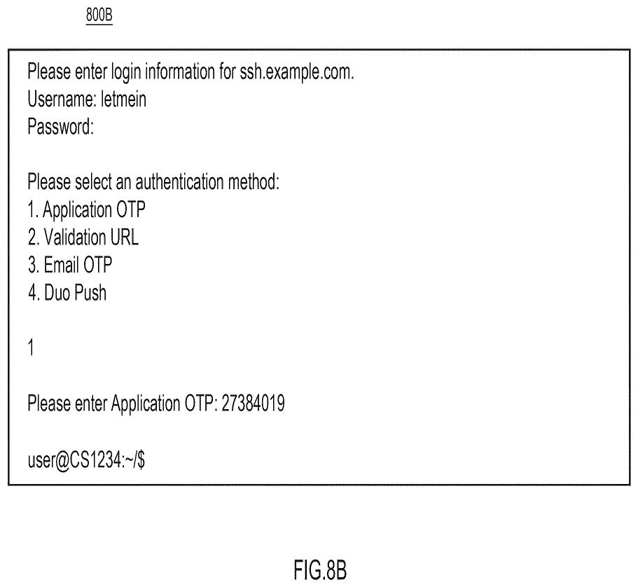

FIG. 8A is a flow diagram illustrating a method 800A for authenticating a user based on one or more authentication methods associated with the user, according to an example embodiment. First, at 801, application programming interface (API) authentication may be performed. That is, for example, an authentication intermediator library may authenticate to an API of an authentication intermediator and a user is requested to provide a login identifier (e.g., login name). Then, at 802, one or more authentication methods associated with the login identifier may be obtained (e.g., from a centralized authentication server). At 803, the user may be authenticated based on the one or more authentication methods. Upon authenticating the user, the user may begin a session to access and/or use resources or services of a system/device at 804. The session may be monitored, and the session is closed at 805 when a criterion is met (e.g., user ends the session or maximum session time is met).

FIG. 8B is diagram illustrating a user interface 800B displaying one or more prompts to a user for selection. For example, the user may be prompted, via the user interface 800B, to provide one or more authentication credentials (e.g., login name and/or password). In certain embodiments, once a login name is provided, one or more authentication methods associated with the user may be obtained and displayed on the user interface 800B. Upon receiving a user selection, the user interface 800B is configured to generate one or more additional prompts corresponding to the selected authentication method. For example, a user may provide as input a selection of “1” (Application OTP) as the authentication method, and the user interface 800B is configured to prompt the user to enter an application OTP. In certain embodiments, the user interface 800B may be a text-based interface, a graphical user interface, or any interface capable of receiving user input.

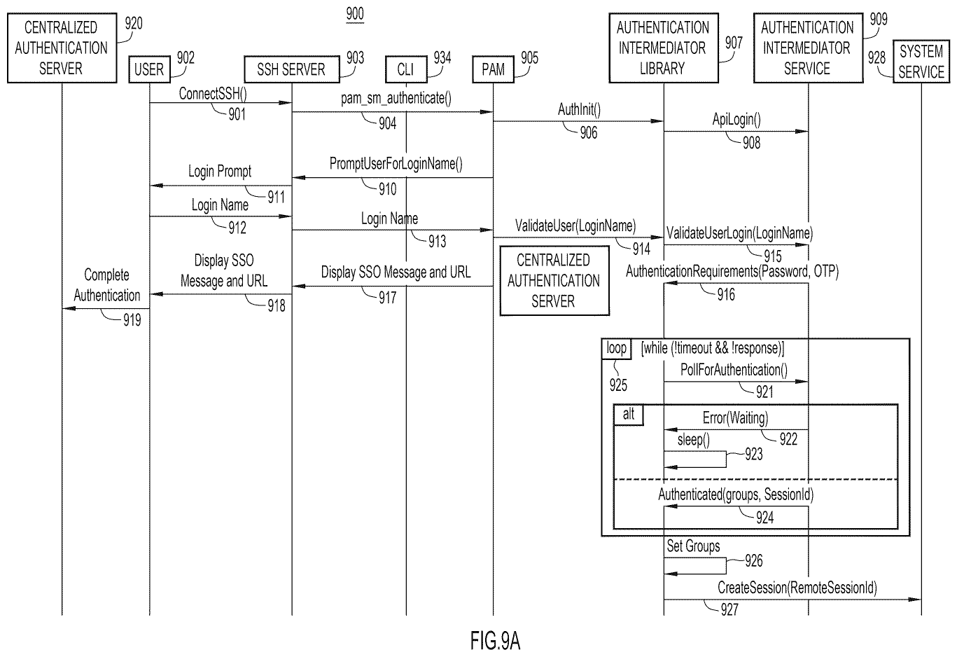

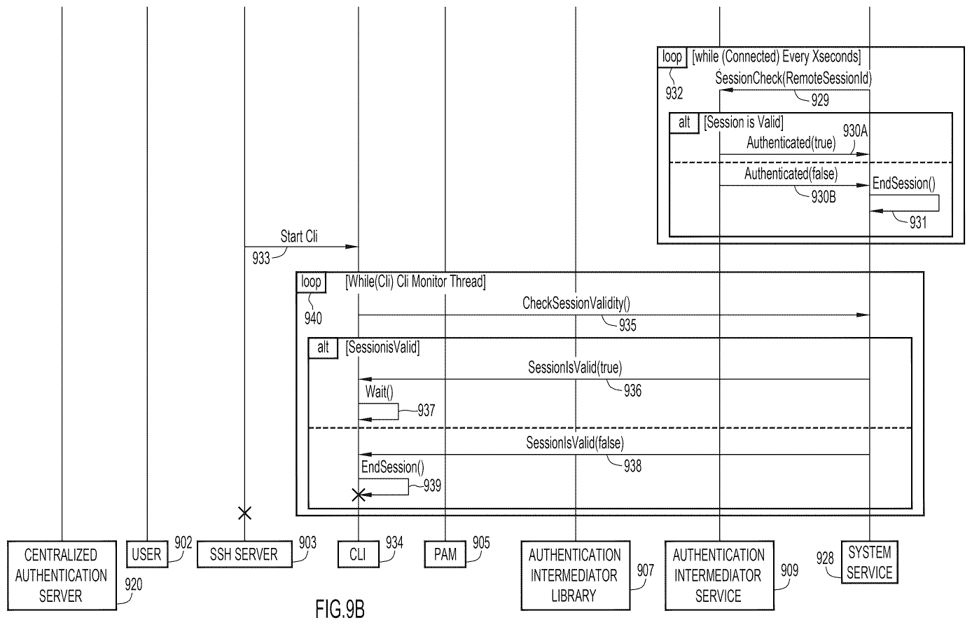

Reference is now made to FIG. 9A and FIG. 9B, for a description of an operational sequence diagram illustrating a method 900 for authenticating a user via an authentication intermediator using a single sign-on (SSO) method. The method 900 begins at 901, where a user 902 initiates a connection with a Secure Shell (SSH) server 903. Then, at 904, the SSH server 903 initiates a pluggable authentication module 905 (PAM) via a function (e.g., “pam_sm_authenticate( )”). At 906, the pluggable authentication module 905 initiates authentication with an authentication intermediator library 907 via a function (e.g., “Authinit( )”). At 908, the authentication intermediator library 907 authenticates to an application programming interface (API) of an authentication intermediator service 909 via a function (e.g., “ApiLogin( )”).

At 910, the pluggable authentication module 905 makes a call to the SSH server 903 to prompt the user 902 for a login name. At 911, the SSH server 903 displays the prompt for login name to the user 902. After the user enters his login name, the login name is provided to the SSH server 903 at 912. Then, at 913, the SSH server 903 provides the login name to the pluggable authentication module 905. At 914, the pluggable authentication module 905 validates the login name with the authentication intermediator library 907. At 915, the authentication intermediator library 907 validates the login name with the authentication intermediator service 909. At 916, the authentication intermediator service 909 provides authentication requirements, including password and one-time password (OTP), to the authentication intermediator library 907.

Then, at 917, the pluggable authentication module 905 makes a call to the SSH server 903 to display a SSO message and URL to the user 902. Then, at 918, the SSH server 903 displays the SSO message and URL to the user 902. At 919, the user 902 completes authentication with a centralized authentication server 920 by following the instructions on the SSO message and URL. At 921, the authentication intermediator library 907 polls the authentication intermediator service 909 for an authentication status. At 922, the authentication intermediator service 909 waits for an error from the authentication intermediator library 907. At 923, the authentication intermediator library 907 may remain in “sleep” mode until the authentication intermediator service 909 authenticates the user 902. Once the user authenticates, at 724, the authentication intermediator service 909 sends to the authentication intermediator library 907 an authenticated status, one or more user permission groups, and a new session identifier. The operations 921, 922, 923, and 924 may proceed iteratively in a loop 925 while a timeout criterion is not met and while a response (e.g., authentication status) has not been received. Then, at 926, the authentication intermediator library 907 sets the one or more user permission groups. At 927, the authentication intermediator library 907 creates a remote session based on the new session identifier (e.g., remote session identifier) at a system service 928.

With continued reference to FIG. 9A, FIG. 9B continues to illustrate the method 900 for authenticating a user via an authentication intermediator using a SSO method. At 929, the system service 928 periodically checks (e.g., every x seconds) for session termination while the user 902 is connected to the system service 928. While the session remains valid, the authentication intermediator service 909 may authenticate the user 902 at 930A and 930B. If authentication fails (authenticated=false), then the system service 928 ends the session at 931. The operations 929, 930A-B, and 931 may proceed iteratively in a loop 932 until a stopping criterion is met (e.g., the session ends or the session is no longer valid).

At 933, the SSH server 903 initiates a command line interface 934 (CLI). At 935, the command line interface 934 makes a call to the system service 928 to check the validity of a session. In response, the system service 928 may report that the session is valid at 936. If the session is valid, then the command line interface 934 waits for the session at 937. However, if the system service 928 reports that the session is not valid at 938, then the session may be ended at 939. The operations 935, 936, 937, 938, and 939 may proceed iteratively in a loop 940 while a CLI monitor thread remains active.

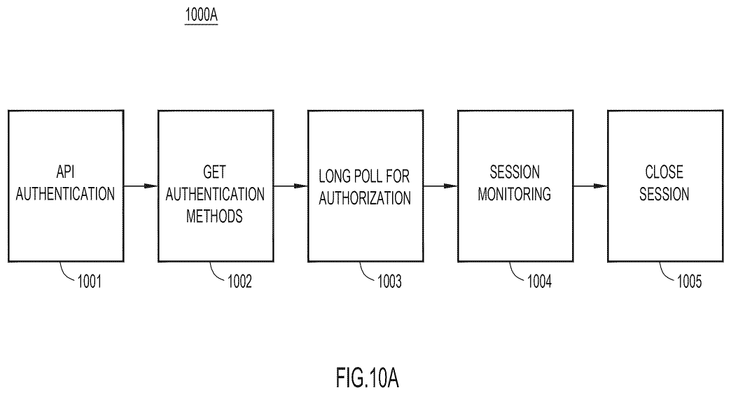

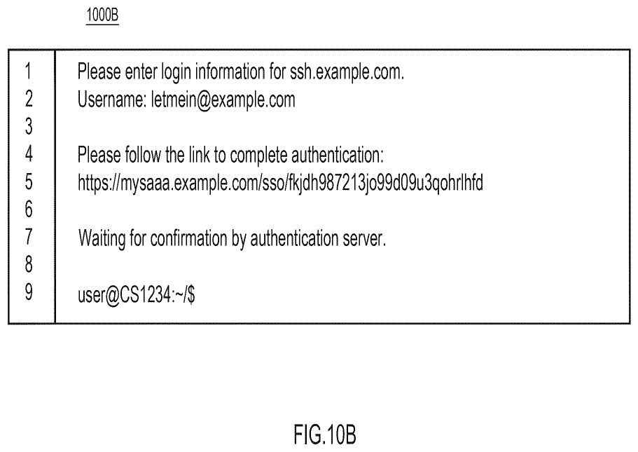

FIG. 10A is a flow diagram illustrating a method 1000A for authenticating a user based on one or more authentication methods associated with the user, according to an example embodiment. First, at 1001, application programming interface (API) authentication may be performed. That is, for example, an authentication intermediator library may authenticate to an API of an authentication intermediator and a user is requested to provide a login identifier (e.g., login name). Then, at 1002, one or more authentication methods associated with the login identifier may be obtained (e.g., from a centralized authentication server). At 1003, a long poll for authorization may be performed. Upon receiving an authorization status, the user may begin a session to access and/or use resources or services of a system/device at 1004. The session may be monitored, and the session is closed at 1005 when a criterion is met (e.g., user ends the session or maximum session time is met).

FIG. 10B is diagram illustrating a user interface 1000B displaying instructions to a user to complete authentication via an authentication URL, according to an example embodiment. For example, the user may be prompted, via the user interface 1000B, to provide one or more authentication credentials (e.g., login name). Once a login name is provided, an authentication link (e.g., URL) may be displayed to the user. The user may be prompted to click on the link and complete the authentication procedure in accordance with instructions provided at a webpage associated with the link. The user interface 1000B may continue to provide a message that confirmation by an authentication server is needed until the user completes the authentication process. In certain embodiments, the user interface 1000B may be a text-based interface, a graphical user interface, or any interface capable of receiving user input.

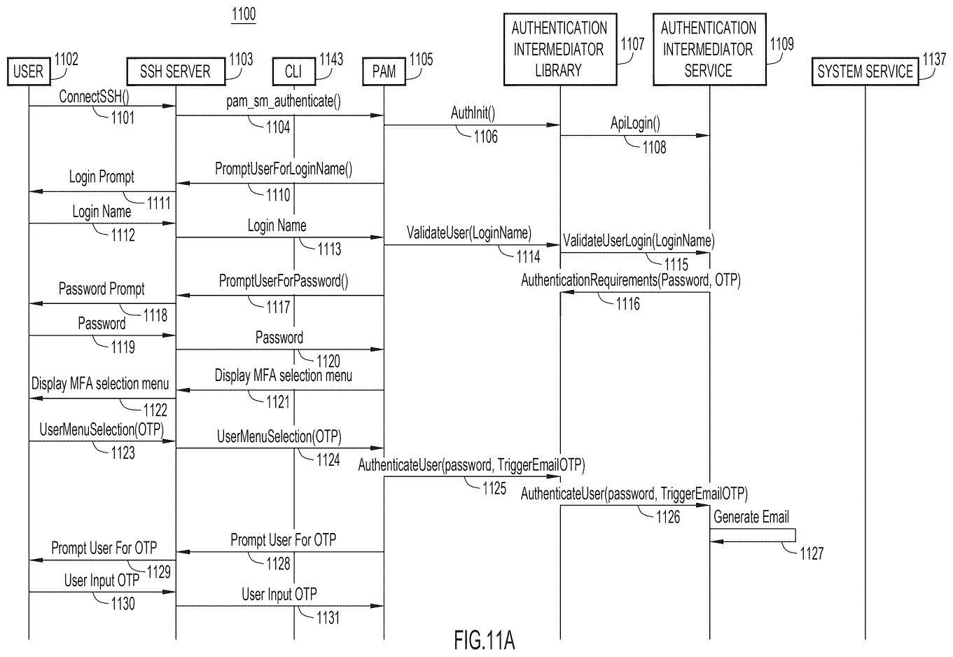

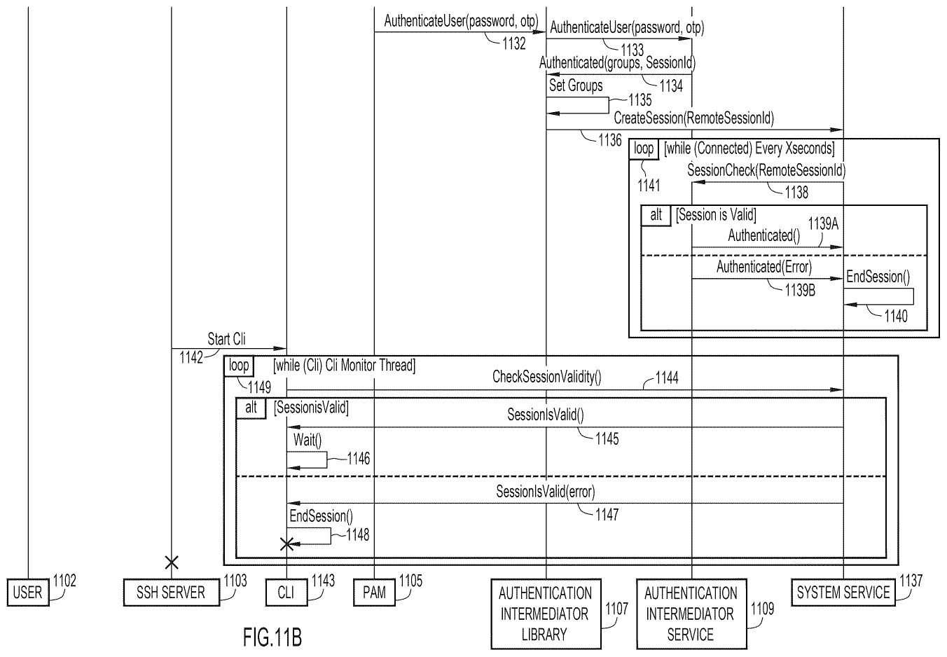

Reference is now made to FIG. 11A and FIG. 11B, for a description of an operational sequence diagram illustrating a method 1100 for authenticating a user via an authentication intermediator using multi-factor authentication, according to an example embodiment. The method 1100 begins at 1101, where a user 1102 initiates a connection with a Secure Shell (SSH) server 1103. Then, at 1104, the SSH server 1103 initiates a pluggable authentication module 1105 (PAM) via a function (e.g., “pam_sm_authenticate( )”). At 1106, the pluggable authentication module 1105 initiates authentication with an authentication intermediator library 1107 via a function (e.g., “Authinit( )”). At 1108, the authentication intermediator library 1107 authenticates to an application programming interface (API) of an authentication intermediator service 1109 via a function (e.g., “ApiLogin( )”).

At 1110, the pluggable authentication module 1105 makes a call to the SSH server 1103 to prompt the user 1102 for a login name. At 1111, the SSH server 1103 displays the prompt for login name to the user 1102. After the user enters his login name, the login name is provided to the SSH server 1103 at 1112. Then, at 1113, the SSH server 1103 provides the login name to the pluggable authentication module 1105. At 1114, the pluggable authentication module 1105 validates the login name with the authentication intermediator library 1107. At 1115, the authentication intermediator library 1107 validates the login name with the authentication intermediator service 1109. At 1116, the authentication intermediator service 1109 provides authentication requirements, including password and one-time password (OTP), to the authentication intermediator library 1107.

Then, at 1117, based on the authentication requirements, the pluggable authentication module 1105 makes a call to the SSH server 1103 to prompt the user 1102 to provide password. At 1118, the SSH server 1103 prompts the user 1102 to provide the password. At 1119, the user 1102 provides the password to the SSH server 1103. At 1120, the SSH server 1103 provides the password to the pluggable authentication module 1105. At 1121, the pluggable authentication module 1105 makes a call to display a multi-factor (MFA) selection menu to the user 1102 to the SSH server 1103. At 1122, the SSH server 1103 displays the MFA selection menu to the user 1102.

At 1123, the user 1102 selects an MFA method. For example, the user 1102 may select an application one-time password (OTP) as the MFA method. At 1124, the SSH server 1103 provides the MFA method selection (e.g., application OTP) to the pluggable authentication module 1105. At 1125, the pluggable authentication module 1105 provides the password and a request to trigger Email OTP to the authentication intermediator library 1107. At 1126, the authentication intermediator library 1107 provides the password and the request to trigger Email OTP to the authentication intermediator service 1109. Then, at 1127, the authentication intermediator service 1109 generates an email with a one-time password that may be sent to the user 1102.

Then, at 1128, the pluggable authentication module 1105 calls the SSH server 1103 to prompt the user 1102 for OTP. At 1129, the SSH server 1103 prompts the user 1102 for OTP. Then, at 1130, the user 1102 provide OTP as input to the SSH server 1103. At 1131, the SSH server 1103 provides the user-provided OTP to the pluggable authentication module 1105.

With continued reference to FIG. 11A, FIG. 11B continues to illustrate the method 1100 for authenticating a user via an authentication intermediator using multi-factor authentication, according to an example embodiment. At 1132, the pluggable authentication module 1105 makes a call to the authentication intermediator library 1107 to authenticate the user 1102 based on the password and the OTP. At 1133, the authentication intermediator library 1107 makes a call to the authentication intermediator service 1109 to authenticate the user 1102 based on the password and the OTP. Once the user authenticates, at 1134, the authentication intermediator service 1109 sends to the authentication intermediator library 1107 an authentication status (e.g., authenticated==True), one or more user permission groups, and a new session identifier. Then, at 1135, the authentication intermediator library 1107 sets the one or more user permission groups. At 1136, the authentication intermediator library 1107 creates a remote session based on the new session identifier (e.g., remote session identifier) at a system service 1137.

Then, at 1138, the system service 1137 periodically checks (e.g., every x seconds) for session termination while the user 1102 is connected to the system service 1137. While the session remains valid, the authentication intermediator service 1109 may authenticate the user 1102 at 1139A and 1139B. If authentication fails (authenticated=false), then the system service 1137 ends the session at 1140. The operations 1138, 1139A-B, and 1140 may proceed iteratively in a loop 1141 until a stopping criterion is met (e.g., the session ends).

At 1142, the SSH server 1103 initiates a command line interface 1143 (CLI). At 1144, the command line interface 1143 makes a call to the system service 1137 to check the validity of a session. In response, the system service 1137 may report that the session is valid at 1145. If the session is valid, then the command line interface 1143 waits for the session at 1146. However, if the system service 1137 reports that the session is not valid at 1147, then the session may be ended at 1148. The operations 1144, 1145, 1146, 1147, and 1148 may proceed iteratively in a loop 1149 while a CLI monitor thread remains active.

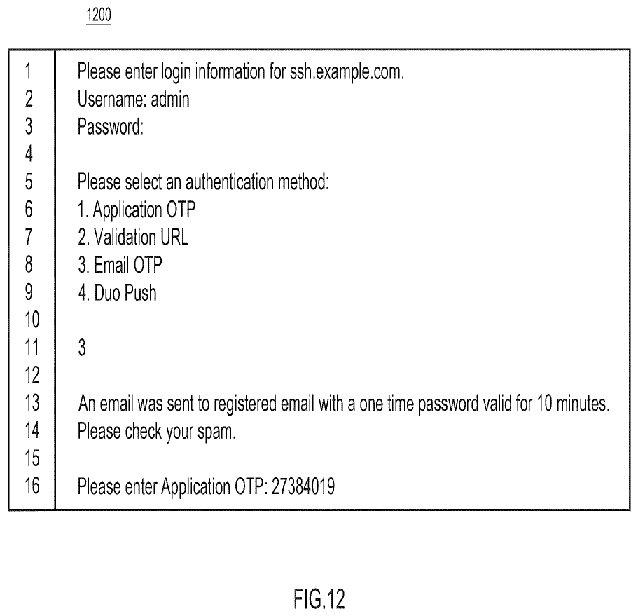

FIG. 12 is diagram illustrating a user interface 1200 displaying one or more prompts to a user for selection of an authentication method, according to an example embodiment. For example, the user may be prompted, via the user interface 1200, to provide one or more authentication credentials (e.g., login name and/or password). In certain embodiments, once a login name is provided, one or more authentication methods associated with the user may be obtained and displayed on the user interface 1200. Upon receiving a user selection, the user interface 1200 is configured to generate one or more additional prompts corresponding to the selected authentication method. For example, a user may provide as input a selection of “3” (Email OTP) as the authentication method, and the user interface 1200 is configured to display a message that an email with a one-time password was sent to the user's email and the one time password is valid for a specified duration. The user interface 1200 may further include a prompt for the user to provide the one time password. In certain embodiments, the user interface 1200 may be a text-based interface, a graphical user interface, or any interface capable of receiving user input.

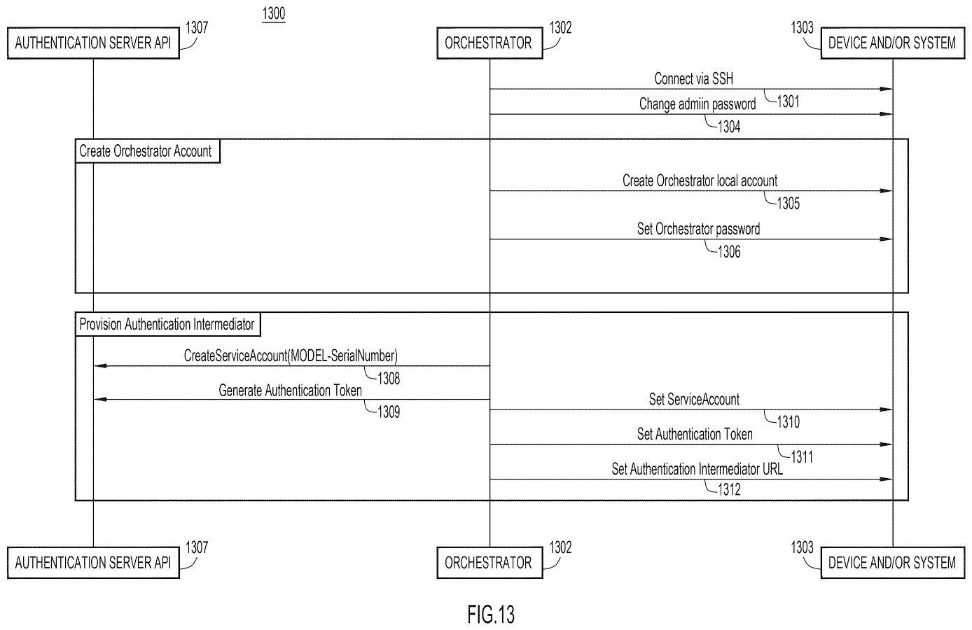

Reference is now made to FIG. 13, for a description of an operational sequence diagram illustrating a method 1300 for configuring a device and/or system via an orchestrator, according to an example embodiment. The method 1300 begins at 1301, where an orchestrator 1302 connects, via SSH, with a device and/or system 1303. At 1304, the orchestrator 1302 changes an administrator password at the device and/or system 1303. Then, the orchestrator 1302 creates an orchestrator local account for the device and/or system 1303 at 1305 and sets an orchestrator password at 1306. To provision an authentication intermediator, the orchestrator 1302 connects with an authentication server application programming interface 1307 to create a service account based on a model serial number at 1308. Then, at 1309, the orchestrator 1302 generates an authentication token. Based on the service account and the authentication token, the orchestrator 1302 sets the service account for the device and/or system 1303 at 1310, sets the authentication token for the device and/or system 1303 at 1311, and sets an authentication intermediator URL for the device and/or system 1303 at 1312. In certain embodiments, the orchestrator 1302 may be a controller (e.g., network controller) configured to manage and/or set up one or more devices, applications, and/or services in a network

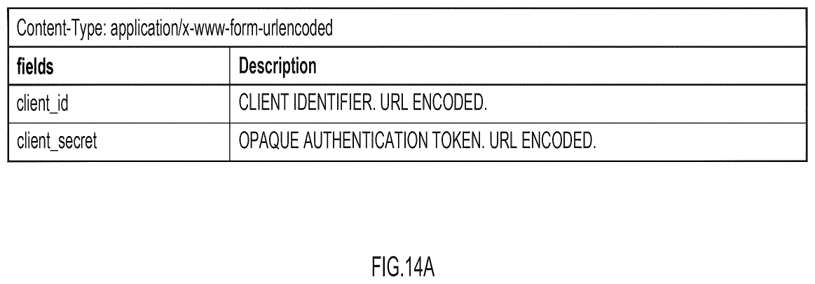

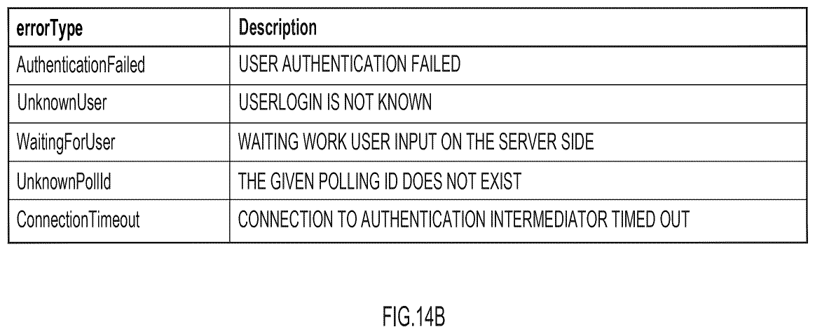

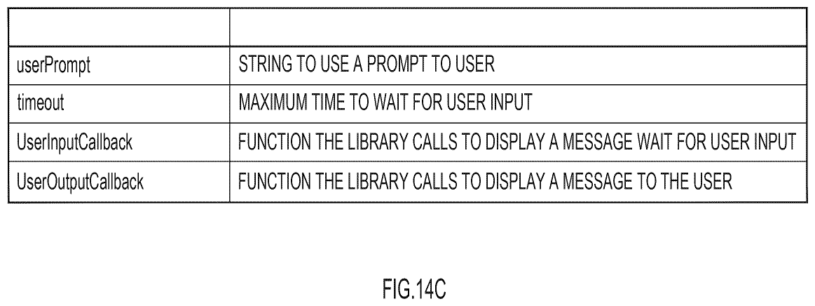

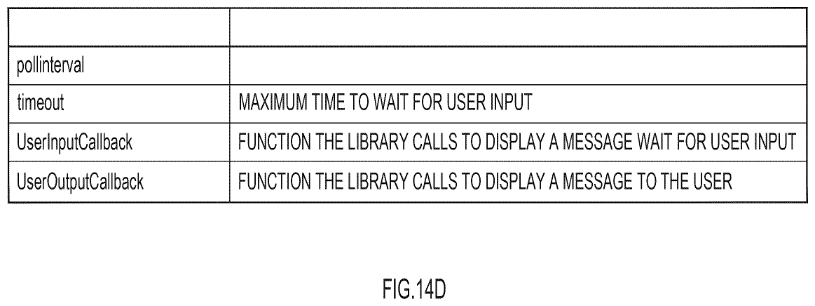

FIG. 14A is a diagram illustrating data fields and corresponding description associated with an authentication intermediator, according to an example embodiment. The exemplary data fields may include a client identifier (“client_id”) and opaque authentication token (“client_secret”).

FIG. 14B is a diagram illustrating error types and corresponding description associated with instantiation of an authentication session, according to an example embodiment. The exemplary error types may include indication of failed authentication, unknown user login, indication of waiting for user input, unknown polling identifier, and connection to authentication intermediator has timed out.

FIG. 14C is a diagram illustrating data fields and corresponding description associated with obtaining authentication credentials from a user, according to an example embodiment. The exemplary data fields include a prompt to the user, a maximum time to wait for user input, a function the library calls to display a message waiting for user input, and a function the library calls to display a message to the user.

FIG. 14D is a diagram illustrating data fields and corresponding description associated with a polling operation, according to an example embodiment. The exemplary data fields include a polling interval, a maximum time to wait for user input, a function the library calls to display a message waiting for user input, and a function the library calls to display a message to the user.

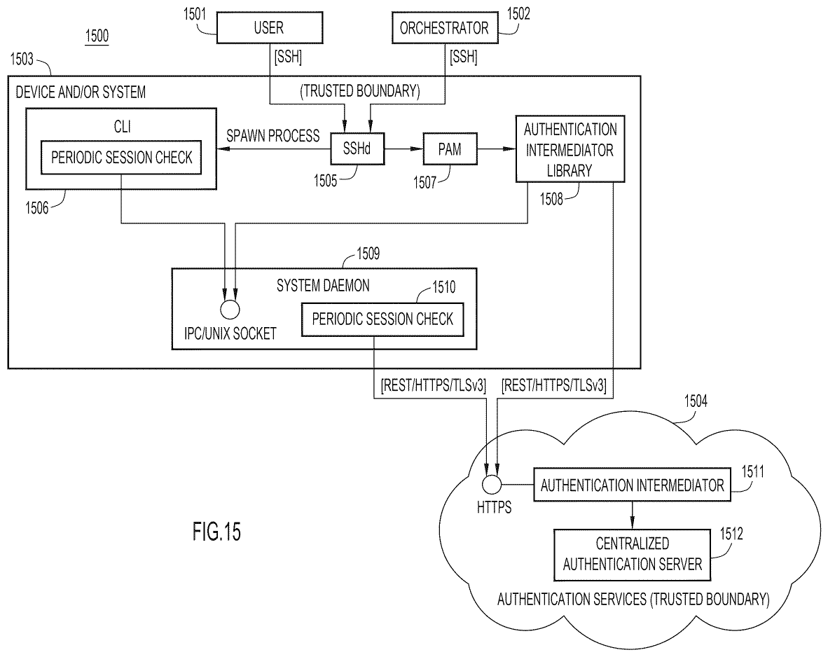

FIG. 15 is a block diagram illustrating a system 1500 for providing authentication services via an authentication intermediator, according to an example embodiment. The system 1500 includes a user 1501, an orchestrator 1502, a device and/or system 1503, and an authentication service 1504. The orchestrator 1502 may be a controller (e.g., network controller) configured to manage and/or set up one or more devices, applications, and/or services in a network.

The device and/or system 1503 includes a Secure Shell Daemon 1505 (SSHd), a command line interface 1506 (CLI), a pluggable authentication module 1507 (PAM) (e.g., a Linux® PAM, such as “pam_intermediator”), authentication intermediator library 1508 (e.g., “libauthentication”), and a system daemon 1509. The user 1501 and the orchestrator 1502 may be connected to the device and/or system 1503 via the Secure Shell Daemon 1505. Then, the Secure Shell Daemon 1505 is configured to spawn a process to initiate the command line interface 1506. Further, the Secure Shell Daemon 1505 is configured to call the pluggable authentication module 1507, which is configured to call the authentication intermediator library 1508. The command line interface 1506 and the authentication intermediator library 1508 are configured to connect with the system daemon 1509 through interprocess communication (IPC) via Unix® sockets. For example, the command line interface 1506 may perform periodic session check through IPC via Unix® sockets.

The system daemon 1509 is configured to perform a periodic session check 1510 on the authentication service 1504 via a Representational State Transfer (REST) framework, a Hypertext Transfer Protocol Secure (HTTPS) protocol, and/or a Transport Layer Security (TLS) V3 protocol. Moreover, the authentication intermediator library 1508 is connected to the authentication service 1504 via the REST framework, the HTTPS protocol, or the TLSV3 protocol. The authentication service 1504 includes an authentication intermediator 1511 and a centralized authentication server 1512. In certain embodiments, the device and/or system 1503 and/or the authentication service 1504 may be considered trusted boundary in a threat model associated with an authentication system.

In certain embodiments, after the user 1501 connects to the Secure Shell Daemon 1505, the Secure Shell Daemon 1505 initializes the pluggable authentication module 1507. Then, the pluggable authentication module 1507 initializes the authentication intermediator library 1508. The authentication intermediator library 1508 connects to the authentication intermediator 1511 and authenticates to an application programming interface (API) of the authentication intermediator 1511. Then, the pluggable authentication module 1507 requests the user 1501 to enter his login name (or any login identifier). After the user 1501 enters his login name, the pluggable authentication module 1507 uses the authentication intermediator library 1508 to validate the login name. The authentication intermediator 1511 validates the login name with the centralized authentication server 1512 and requests one or more authentication methods associated with the user 1501 from the centralized authentication server 1512. In one embodiment, an authentication URL may be displayed to the user. The user connects to the URL and completes the authentication process.

In certain embodiments, the authentication intermediator library 1508 polls the authentication intermediator 1511 to get an authentication status. Once the user 1501 authenticates, the authentication intermediator 1511 may send to the authentication intermediator library 1508 a new session identifier and one or more user permissions. Then, the authentication intermediator library 1508 sets user permissions on the a local authentication server. The Secure Shell Daemon 1505 spawns the command line interface 1506. The command line interface 1506 periodically checks for session termination. In certain embodiments, when the command line interface 1506 terminates, the Secure Shell Daemon 1505 call the pluggable authentication module 1507 to close the session. After the pluggable authentication module 1507 closes the session, the pluggable authentication module 1507 notifies the authentication intermediator 1511 via the authentication intermediator library 1508 that the session has ended. The authentication intermediator 1511 ends the session on the centralized authentication server 1512. In certain embodiments, an administrator may periodically update the centralized authentication server 1512 as additional authentication methods become available. For example, the additional authentication methods may include (1) strict-intermediator: only remote authentication is allowed, (2) intermediator-local: use remote authentication and then local accounts, or (3) intermediator-local-serial: use remote authentication first, then local account authentication only if it is via the serial port.

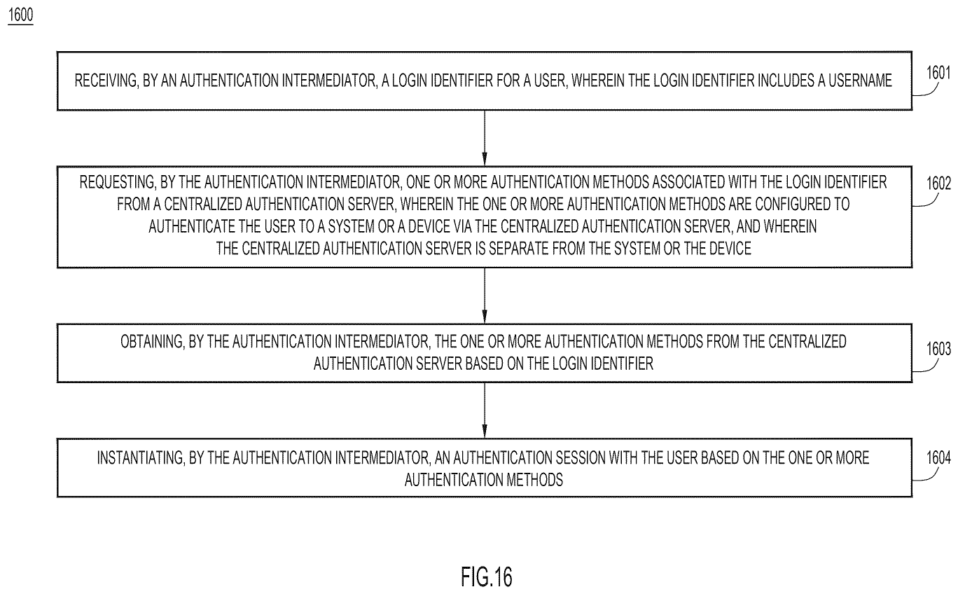

FIG. 16 is a flow diagram illustrating a method 1600 for instantiating an authentication session with a user, according to an example embodiment.

At 1601, the method 1600 involves receiving, by an authentication intermediator, a login identifier for a user, wherein the login identifier includes a username.

At 1602, the method 1600 involves requesting, by the authentication intermediator, one or more authentication methods associated with the login identifier from a centralized authentication server, wherein the one or more authentication methods are configured to authenticate the user to a system or a device via the centralized authentication server, and wherein the centralized authentication server is separate from the system or the device.

At 1603, the method 1600 involves obtaining, by the authentication intermediator, the one or more authentication methods from the centralized authentication server based on the login identifier.

At 1604, the method 1600 involves instantiating, by the authentication intermediator, an authentication session with the user based on the one or more authentication methods.

In the method 1600, instantiating further involves presenting an authentication interface configured to display the one or more authentication methods to the user, and authenticating the user based on the at least one authentication method selected by the user.

In the method 1600, authenticating further involves providing an authentication status to an authentication intermediator library in the system or the device, wherein the authentication status is provided in response to a polling request from the authentication intermediator library.

In the method 1600, wherein the system includes a computer system comprising one or more software applications, and wherein the device includes a user device or a network device.

In the method 1600, instantiating further involves responsive to the user successfully authenticating to the system or the device, sending a session identifier and one or more user permissions to an authentication intermediator library in the system or the device, wherein a local authentication server on the system or the device is configured to manage access of the user to the system or the device based on the session identifier and the one or more user permissions.

In the method 1600, wherein the one or more authentication methods include one or more primary authentication methods and one or more secondary authentication methods, and wherein the one or more primary authentication methods are presented to the user for selection prior to the one or more secondary authentication methods being presented.

In the method 1600, wherein the user connects to the authentication intermediator via a pluggable authentication module (PAM).

In the method 1600, further including updating the one or more authentication methods stored on the centralized authentication server based on one or more additional authentication methods associated with the user.

In the method 1600, wherein the authentication intermediator is a function running on a server or computing device that is separate from the device or the system.

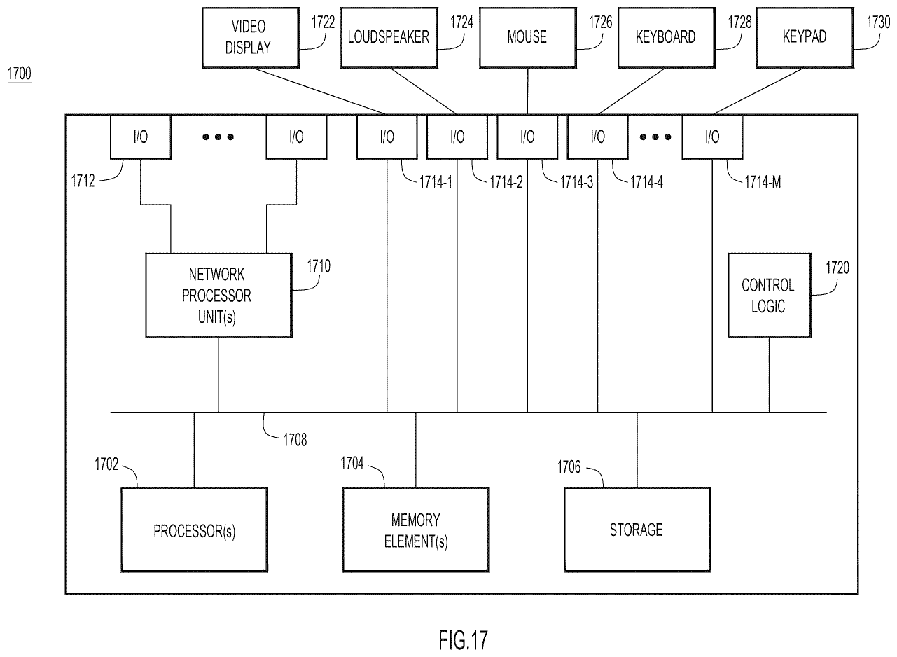

Referring to FIG. 17, FIG. 17 illustrates a hardware block diagram of a computing device 1700 that may perform functions associated with operations discussed herein in connection with the techniques depicted in FIGS. 1-4, 5A, 5B, 6A, 6B, 7A, 7B, 8A, 8B, 9A, 9B, 10A, 10B, 11A, 11B, 12, 13, 14A, 14B, 14C, 14D, 15, and 16. In various embodiments, a computing device or apparatus, such as computing device 1700 or any combination of computing devices 1700, may be configured as any entity/entities as discussed for the techniques depicted in connection with FIGS. 1-4, 5A, 5B, 6A, 6B, 7A, 7B, 8A, 8B, 9A, 9B, 10A, 10B, 11A, 11B, 12, 13, 14A, 14B, 14C, 14D, 15, and 16 in order to perform operations of the various techniques discussed herein.

In at least one embodiment, the computing device 1700 may be any apparatus that may include one or more processor(s) 1702, one or more memory element(s) 1704, storage 1706, a bus 1708, one or more network processor unit(s) 1710 interconnected with one or more network input/output (I/O) interface(s) 1712, one or more I/O interface(s) 1714-1, 1714-2, 1714-3, 1714-4, . . . , 1714-M, and control logic 1720. In various embodiments, instructions associated with logic for computing device 1700 can overlap in any manner and are not limited to the specific allocation of instructions and/or operations described herein.

In at least one embodiment, processor(s) 1702 is/are at least one hardware processor configured to execute various tasks, operations and/or functions for computing device 1700 as described herein according to software and/or instructions configured for computing device 1700. Processor(s) 1702 (e.g., a hardware processor) can execute any type of instructions associated with data to achieve the operations detailed herein. In one example, processor(s) 1702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1704 and/or storage 1706 is/are configured to store data, information, software, and/or instructions associated with computing device 1700, and/or logic configured for memory element(s) 1704 and/or storage 1706. For example, any logic described herein (e.g., control logic 1720) can, in various embodiments, be stored for computing device 1700 using any combination of memory element(s) 1704 and/or storage 1706. Note that in some embodiments, storage 1706 can be consolidated with memory element(s) 1704 (or vice versa), or can overlap/exist in any other suitable manner.

In at least one embodiment, bus 1708 can be configured as an interface that enables one or more elements of computing device 1700 to communicate in order to exchange information and/or data. Bus 1708 can be implemented with any architecture designed for passing control, data and/or information between processors, memory elements/storage, peripheral devices, and/or any other hardware and/or software components that may be configured for computing device 1700. In at least one embodiment, bus 1708 may be implemented as a fast kernel-hosted interconnect, potentially using shared memory between processes (e.g., logic), which can enable efficient communication paths between the processes.

In various embodiments, network processor unit(s) 1710 may enable communication between computing device 1700 and other systems, entities, etc., via network I/O interface(s) 1712 (wired and/or wireless) to facilitate operations discussed for various embodiments described herein. In various embodiments, network processor unit(s) 1710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1700 and other systems, entities, etc. to facilitate operations for various embodiments described herein. In various embodiments, network I/O interface(s) 1712 can be configured as one or more Ethernet port(s), Fibre Channel ports, any other I/O port(s), and/or antenna(s)/antenna array(s) now known or hereafter developed. Thus, the network processor unit(s) 1710 and/or network I/O interface(s) 1712 may include suitable interfaces for receiving, transmitting, and/or otherwise communicating data and/or information in a network environment.

I/O interface(s) 1714-1 to 1714-M allow for input and output of data and/or information with other entities that may be connected to computing device 1700. For example, I/O interface(s) 1714-1 to 1714-M may provide a connection to external devices such as a video display (e.g., touch-screen display) 1722, loudspeaker 1724, mouse 1726, keyboard 1728, keypad 1730, and/or any other suitable input and/or output device now known or hereafter developed. It is also envisioned that many of these external devices may be integrated as part of the computing device 1700. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1720 can include instructions that, when executed, cause processor(s) 1702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1704 and/or storage 1706 can store data, software, code, instructions (e.g., processor instructions), logic, parameters, combinations thereof, and/or the like used for operations described herein. This includes memory element(s) 1704 and/or storage 1706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method including: receiving, by an authentication intermediator, a login identifier for a user, wherein the login identifier includes a username; requesting, by the authentication intermediator, one or more authentication methods associated with the login identifier from a centralized authentication server, wherein the one or more authentication methods are configured to authenticate the user to a system or a device via the centralized authentication server, and wherein the centralized authentication server is separate from the system or the device; obtaining, by the authentication intermediator, the one or more authentication methods from the centralized authentication server based on the login identifier; and instantiating, by the authentication intermediator, an authentication session with the user based on the one or more authentication methods.

In some aspects, the techniques described herein relate to a method, wherein instantiating includes: presenting an authentication interface configured to display the one or more authentication methods to the user; receiving a user selection of at least one authentication method from the one or more authentication methods; and authenticating the user based on the at least one authentication method selected by the user.

In some aspects, the techniques described herein relate to a method, wherein authenticating includes: providing an authentication status to an authentication intermediator library in the system or the device, wherein the authentication status is provided in response to a polling request from the authentication intermediator library.

In some aspects, the techniques described herein relate to a method, wherein the system includes a computer system including one or more software applications, and wherein the device includes a user device or a network device.

In some aspects, the techniques described herein relate to a method, wherein instantiating includes: responsive to the user successfully authenticating to the system or the device, sending a session identifier and one or more user permissions to an authentication intermediator library in the system or the device, wherein a local authentication server on the system or the device is configured to manage access of the user to the system or the device based on the session identifier and the one or more user permissions.

In some aspects, the techniques described herein relate to a method, wherein the one or more authentication methods include one or more primary authentication methods and one or more secondary authentication methods, and wherein the one or more primary authentication methods are presented to the user for selection prior to the one or more secondary authentication methods being presented.

In some aspects, the techniques described herein relate to a method, wherein the user connects to the authentication intermediator via a pluggable authentication module (PAM).

In some aspects, the techniques described herein relate to a method, further including: updating the one or more authentication methods stored on the centralized authentication server based on one or more additional authentication methods associated with the user.

In some aspects, the techniques described herein relate to a method, wherein the authentication intermediator is a function running on a server or computing device that is separate from the device or the system.

In some aspects, the techniques described herein relate to an apparatus including: a network interface that enables network communication; a memory; and one or more processors coupled to the network interface and the memory, wherein the one or more processors are configured to perform operations including: receiving a login identifier for a user, wherein the login identifier includes a username; requesting one or more authentication methods associated with the login identifier from a centralized authentication server, wherein the one or more authentication methods are configured to authenticate the user to a system or a device via the centralized authentication server, and wherein the centralized authentication server is separate from the system or the device; obtaining the one or more authentication methods from the centralized authentication server based on the login identifier; and instantiating an authentication session with the user based on the one or more authentication methods.

In some aspects, the techniques described herein relate to an apparatus, wherein instantiating includes: presenting an authentication interface configured to display the one or more authentication methods to the user; receiving a user selection of at least one authentication method from the one or more authentication methods; and authenticating the user based on the at least one authentication method selected by the user.

In some aspects, the techniques described herein relate to an apparatus, wherein authenticating includes: providing an authentication status to an authentication intermediator library in the system or the device, wherein the authentication status is provided in response to a polling request from the authentication intermediator library.

In some aspects, the techniques described herein relate to an apparatus, wherein the system includes a computer system including one or more software applications, and wherein the device includes a user device or a network device.

In some aspects, the techniques described herein relate to an apparatus, wherein instantiating includes: responsive to the user successfully authenticating to the system or the device, sending a session identifier and one or more user permissions to an authentication intermediator library in the system or the device, wherein a local authentication server on the system or the device is configured to manage access of the user to the system or the device based on the session identifier and the one or more user permissions.

In some aspects, the techniques described herein relate to an apparatus, further including: updating the one or more authentication methods stored on the centralized authentication server based on one or more additional authentication methods associated with the user.

In some aspects, the techniques described herein relate to one or more non-transitory computer readable storage media encoded with instructions that, when executed by a processor, cause the processor to: receive a login identifier for a user, wherein the login identifier includes a username; request one or more authentication methods associated with the login identifier from a centralized authentication server, wherein the one or more authentication methods are configured to authenticate the user to a system or a device via the centralized authentication server, and wherein the centralized authentication server is separate from the system or the device; obtain the one or more authentication methods from the centralized authentication server based on the login identifier; and instantiate an authentication session with the user based on the one or more authentication methods.

In some aspects, the techniques described herein relate to one or more non-transitory computer readable storage media, wherein the instructions are operable to cause the processor to instantiate an authentication session with the user based on the one or more authentication methods by: presenting an authentication interface configured to display the one or more authentication methods to the user; receiving a user selection of at least one authentication method from the one or more authentication methods; and authenticating the user based on the at least one authentication method selected by the user.

In some aspects, the techniques described herein relate to one or more non-transitory computer readable storage media, wherein the system includes a computer system including one or more software applications, and wherein the device includes a user device or a network device.

In some aspects, the techniques described herein relate to one or more non-transitory computer readable storage media, wherein the instructions are operable to cause the processor to instantiate an authentication session with the user based on the one or more authentication methods by: responsive to the user successfully authenticating to the system or the device, sending a session identifier and one or more user permissions to an authentication intermediator library in the system or the device, wherein a local authentication server on the system or the device is configured to manage access of the user to the system or the device based on the session identifier and the one or more user permissions.

In some aspects, the techniques described herein relate to one or more non-transitory computer readable storage media, wherein the instructions are operable to cause the processor to: update the one or more authentication methods stored on the centralized authentication server based on one or more additional authentication methods associated with the user.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
receiving, by an authentication intermediator, a login identifier for a user, wherein the login identifier includes a username;
requesting, by the authentication intermediator, one or more authentication methods associated with the login identifier from a centralized authentication server, wherein the one or more authentication methods are configured to authenticate the user to a system or a device via the centralized authentication server, and wherein the centralized authentication server is separate from the system or the device;
obtaining, by the authentication intermediator, the one or more authentication methods from the centralized authentication server based on the login identifier; and
instantiating, by the authentication intermediator, an authentication session with the user based on the one or more authentication methods.

2. The method of claim 1, wherein instantiating comprises:
presenting an authentication interface configured to display the one or more authentication methods to the user;
receiving a user selection of at least one authentication method from the one or more authentication methods; and
authenticating the user based on the at least one authentication method selected by the user.

3. The method of claim 2, wherein authenticating comprises:
providing an authentication status to an authentication intermediator library in the system or the device, wherein the authentication status is provided in response to a polling request from the authentication intermediator library.

4. The method of claim 1, wherein the system includes a computer system comprising one or more software applications, and wherein the device includes a user device or a network device.

5. The method of claim 1, wherein instantiating comprises:
responsive to the user successfully authenticating to the system or the device, sending a session identifier and one or more user permissions to an authentication intermediator library in the system or the device, wherein a local authentication server on the system or the device is configured to manage access of the user to the system or the device based on the session identifier and the one or more user permissions.

6. The method of claim 1, wherein the one or more authentication methods include one or more primary authentication methods and one or more secondary authentication methods, and wherein the one or more primary authentication methods are presented to the user for selection prior to the one or more secondary authentication methods being presented.

7. The method of claim 1, wherein the user connects to the authentication intermediator via a pluggable authentication module (PAM).

8. The method of claim 1, further comprising:
updating the one or more authentication methods stored on the centralized authentication server based on one or more additional authentication methods associated with the user.

9. The method of claim 1, wherein the authentication intermediator is a function running on a server or computing device that is separate from the device or the system.

10. An apparatus comprising:
a network interface that enables network communication;
a memory; and
one or more processors coupled to the network interface and the memory, wherein the one or more processors are configured to perform operations including:
receiving a login identifier for a user, wherein the login identifier includes a username;
requesting one or more authentication methods associated with the login identifier from a centralized authentication server, wherein the one or more authentication methods are configured to authenticate the user to a system or a device via the centralized authentication server, and wherein the centralized authentication server is separate from the system or the device;
obtaining the one or more authentication methods from the centralized authentication server based on the login identifier; and
instantiating an authentication session with the user based on the one or more authentication methods.

11. The apparatus of claim 10, wherein instantiating comprises:
presenting an authentication interface configured to display the one or more authentication methods to the user;
receiving a user selection of at least one authentication method from the one or more authentication methods; and
authenticating the user based on the at least one authentication method selected by the user.

12. The apparatus of claim 11, wherein authenticating comprises:
providing an authentication status to an authentication intermediator library in the system or the device, wherein the authentication status is provided in response to a polling request from the authentication intermediator library.

13. The apparatus of claim 10, wherein the system includes a computer system comprising one or more software applications, and wherein the device includes a user device or a network device.

14. The apparatus of claim 10, wherein instantiating comprises:
responsive to the user successfully authenticating to the system or the device, sending a session identifier and one or more user permissions to an authentication intermediator library in the system or the device, wherein a local authentication server on the system or the device is configured to manage access of the user to the system or the device based on the session identifier and the one or more user permissions.

15. The apparatus of claim 10, further comprising:
updating the one or more authentication methods stored on the centralized authentication server based on one or more additional authentication methods associated with the user.

16. One or more non-transitory computer readable storage media encoded with instructions that, when executed by a processor, cause the processor to:
receive a login identifier for a user, wherein the login identifier includes a username;
request one or more authentication methods associated with the login identifier from a centralized authentication server, wherein the one or more authentication methods are configured to authenticate the user to a system or a device via a the centralized authentication server, and wherein the centralized authentication server is separate from the system or the device;
obtain the one or more authentication methods from the centralized authentication server based on the login identifier; and
instantiate an authentication session with the user based on the one or more authentication methods.

17. The one or more non-transitory computer readable storage media of claim 16, wherein the instructions are operable to cause the processor to instantiate an authentication session with the user based on the one or more authentication methods by:
presenting an authentication interface configured to display the one or more authentication methods to the user;
receiving a user selection of at least one authentication method from the one or more authentication methods; and
authenticating the user based on the at least one authentication method selected by the user.

18. The one or more non-transitory computer readable storage media of claim 16, wherein the system includes a computer system comprising one or more software applications, and wherein the device includes a user device or a network device.

19. The one or more non-transitory computer readable storage media of claim 16, wherein the instructions are operable to cause the processor to instantiate an authentication session with the user based on the one or more authentication methods by:
responsive to the user successfully authenticating to the system or the device, sending a session identifier and one or more user permissions to an authentication intermediator library in the system or the device, wherein a local authentication server on the system or the device is configured to manage access of the user to the system or the device based on the session identifier and the one or more user permissions.

20. The one or more non-transitory computer readable storage media of claim 16, wherein the instructions are operable to cause the processor to:
update the one or more authentication methods stored on the centralized authentication server based on one or more additional authentication methods associated with the user.
